(19) United States
(12) Patent Application Publication
(10) Pub. No.: US 2026/0059538 A1
(43) Pub. Date: Feb. 26, 2026

(54) REDUCED BLIND DECODING FOR DL CONTROL CHANNELS

(71) Applicant: Samsung Electronics Co., Ltd., Suwon-si (KR)

(72) Inventors: Emad Nader Farag, Flanders, NJ (US); Aristides Papasakellariou, Houston, TX (US); Ebrahim MolavianJazi, San Jose, CA (US)

(21) Appl. No.: 19/283,200

(22) Filed: Jul. 28, 2025

Related U.S. Application Data
(60) Provisional application No. 63/685,574, filed on Aug. 21, 2024.
(60) Provisional application No. 63/696,213, filed on Sep. 18, 2024.

(51) Int. Cl. H04W 72/23

(52) U.S. Cl. CPC H04W 72/23

(57) ABSTRACT

Methods and apparatuses for reduced blind decoding for downlink (DL) control channels. A method of operating a user equipment (UE) includes receiving first information for a search space (SS) set, receiving second information for a first channel associated with the SS set, and receiving an instance of the first channel. The instance of the first channel includes third information. The instance of the first channel is associated with a physical downlink control channel (PDCCH) monitoring occasion (MO) of the SS set. The method further includes, based on the third information, identifying a first PDCCH candidate in the PDCCH MO and receiving the first PDCCH candidate. The third information includes a starting control channel element (CCE) of the first PDCCH candidate and an aggregation level (AL) of the first PDCCH candidate.

### CROSS-REFERENCE TO RELATED AND CLAIM OF PRIORITY

The present application claims priority under 35 U.S.C. § 119(e) to U.S. Provisional Patent Application No. 63/685,574 filed on Aug. 21, 2024 and U.S. Provisional Patent Application No. 63/696,213 filed on Sep. 18, 2024 which are hereby incorporated by reference in their entirety.

### TECHNICAL FIELD

The present disclosure relates generally to wireless communication systems and, more specifically, the present disclosure relates to methods and apparatuses for reduced blind decoding for downlink (DL) control channels.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to reduced blind decoding for DL control channels.

In one embodiment, a user equipment (UE) is provided. The UE includes a transceiver configured to receive first information for a search space (SS) set, receive second information for a first channel associated with the SS set, and receive an instance of the first channel. The instance of the first channel includes third information. The instance of the first channel is associated with a physical downlink control channel (PDCCH) monitoring occasion (MO) of the SS set. The UE further includes a processor operably coupled to the transceiver. The processor is configured to, based on the third information, identify a first PDCCH candidate in the PDCCH MO. The transceiver is further configured to receive the first PDCCH candidate. The third information indicates a starting control channel element (CCE) of the first PDCCH candidate and an aggregation level (AL) of the first PDCCH candidate.

In another embodiment, a base station (BS) is provided. The BS includes a transceiver configured to transmit first information for a SS set and transmit second information for a first channel associated with the SS set. The BS further includes a processor operably coupled to the transceiver, the processor is configured to determine third information to identify a first PDCCH candidate. The transceiver is further configured to transmit an instance of the first channel and transmit the first PDCCH candidate in the PDCCH MO. The instance of the first channel includes the third information. The instance of the first channel is associated with the PDCCH MO of the SS set. The third information indicates a starting CCE of the first PDCCH candidate and an AL of the first PDCCH candidate.

In yet another embodiment, a method of operating a UE is provided. The method includes receiving first information for a SS set, receiving second information for a first channel associated with the SS set, and receiving an instance of the first channel. The instance of the first channel includes third information. The instance of the first channel is associated with a PDCCH MO of the SS set. The method further includes, based on the third information, identifying a first PDCCH candidate in the PDCCH MO and receiving the first PDCCH candidate. The third information includes a starting CCE of the first PDCCH candidate and an AL of the first PDCCH candidate.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example UE according to embodiments of the present disclosure;

FIGS. 4A and 4B illustrates an example of a wireless transmit and receive paths according to embodiments of the present disclosure;

FIG. 5A illustrates an example of a wireless system according to embodiments of the present disclosure;

FIG. 5B illustrates an example of a multi-beam operation according to embodiments of the present disclosure;

FIG. 6 illustrates an example of a transmitter structure for beamforming according to embodiments of the present disclosure;

FIG. 7 illustrates an example discontinuous reception (DRX) cycle according to embodiments of the present disclosure;

FIGS. 8A and 8B illustrate examples of physical downlink control channel (PDCCH) monitoring occasions (MOs) according to embodiments of the present disclosure;

FIG. 9 illustrates an example periodicity for a PDCCH slot according to embodiments of the present disclosure;

FIG. 10 illustrates an example periodicity for a PDCCH slot according to embodiments of the present disclosure;

FIG. 11 illustrates an example periodicity for PDCCH slots according to embodiments of the present disclosure;

FIG. 12 illustrates an example periodicity for a PDCCH slot according to embodiments of the present disclosure;

FIG. 13 illustrates an example periodicity for a PDCCH slot according to embodiments of the present disclosure;

FIG. 14 illustrates an example periodicity for PDCCH slots according to embodiments of the present disclosure;

FIGS. 15A, 15B, and 15C illustrate example control channel elements (CCEs) according to embodiments of the present disclosure;

FIGS. 16A, 16B, 16C, 16D, 16E, and 16F illustrate example frequency domain allocations according to embodiments of the present disclosure;

FIG. 17 illustrates an example of PDCCH MOs according to embodiments of the present disclosure;

FIG. 18 illustrates example entries for CCEs according to embodiments of the present disclosure;

FIG. 19 illustrates example entries for radio network temporary identifiers (RNTI) according to embodiments of the present disclosure;

FIG. 20 illustrates examples of PDCCH candidate information according to embodiments of the present disclosure;

FIG. 21 illustrates an example periodicity of channel A according to embodiments of the present disclosure;

FIG. 22 illustrates an example periodicity of channel A according to embodiments of the present disclosure; and

FIG. 23 illustrates an example method performed by a UE in a wireless communication system according to embodiments of the present disclosure.

### DETAILED DESCRIPTION

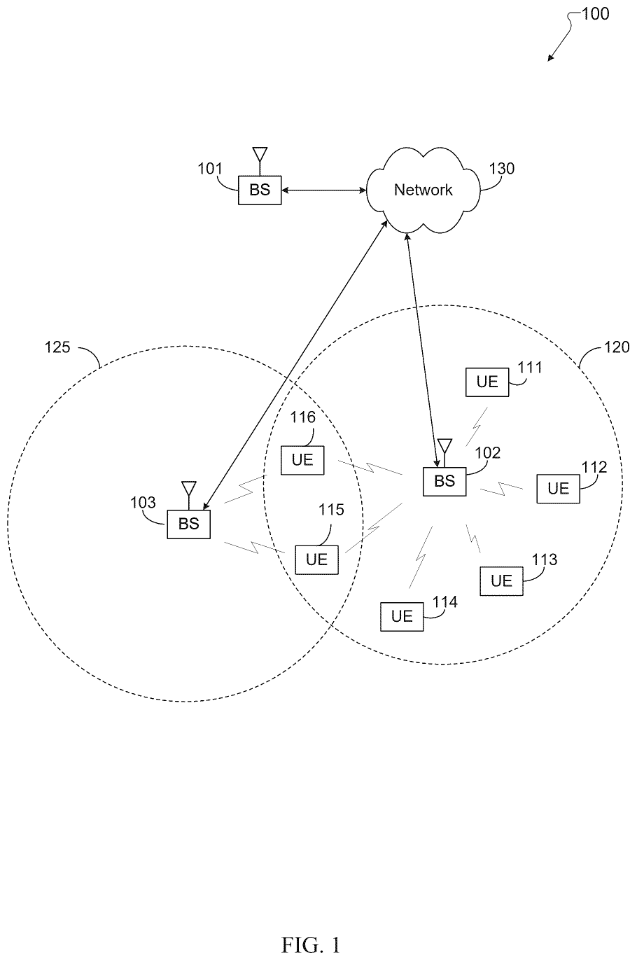

FIGS. 1-23, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein: [REF 1] 3GPP TS 38.211 v18.3.0, “NR; Physical channels and modulation;” [REF 2] 3GPP TS 38.212 v18.3.0, “NR; Multiplexing and Channel coding;” [REF 3] 3GPP TS 38.213 v18.3.0, “NR; Physical Layer Procedures for Control;” [REF 4] 3GPP TS 38.214 v18.3.0, “NR; Physical Layer Procedures for Data;” [REF 5] 3GPP TS 38.321 v18.2.0, “NR; Medium Access Control (MAC) protocol specification;” and [REF 6] 3GPP TS 38.331 v18.2.0, “NR; Radio Resource Control (RRC) Protocol Specification.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the LUE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for reduced blind decoding for DL control channels. In certain embodiments, one or more of the BSs 101-103 include circuitry, programing, or a combination thereof to support reduced blind decoding for DL control channels.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

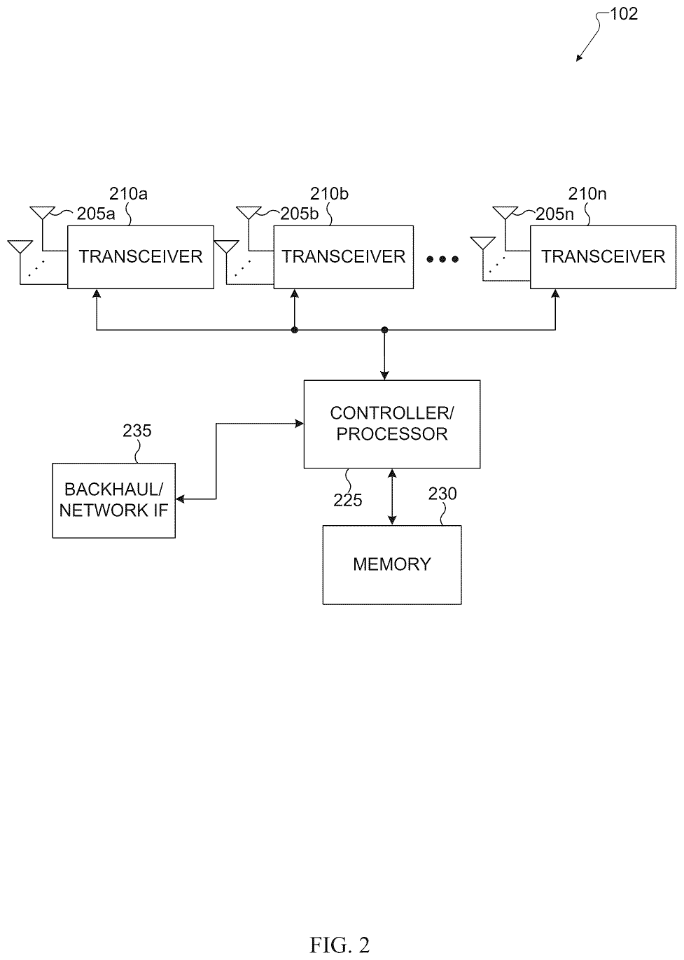

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channels or signals and the transmission of downlink (DL) channels or signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as supporting reduced blind decoding for DL control channels. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

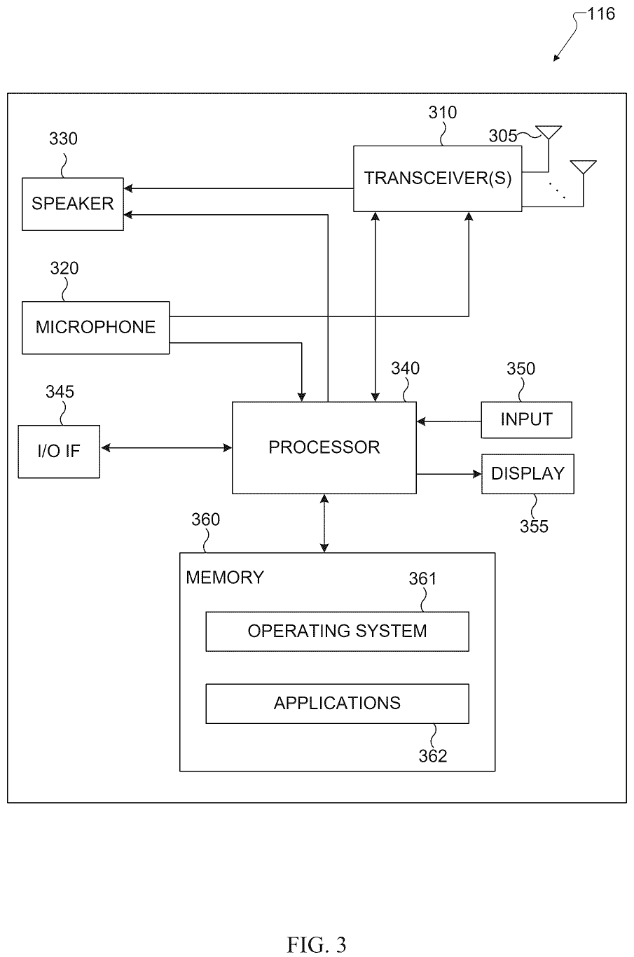

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the ULE 116. For example, the processor 340 could control the reception of DL channels or signals and the transmission of UL channels or signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes that utilize reduced blind decoding for DL control channels as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

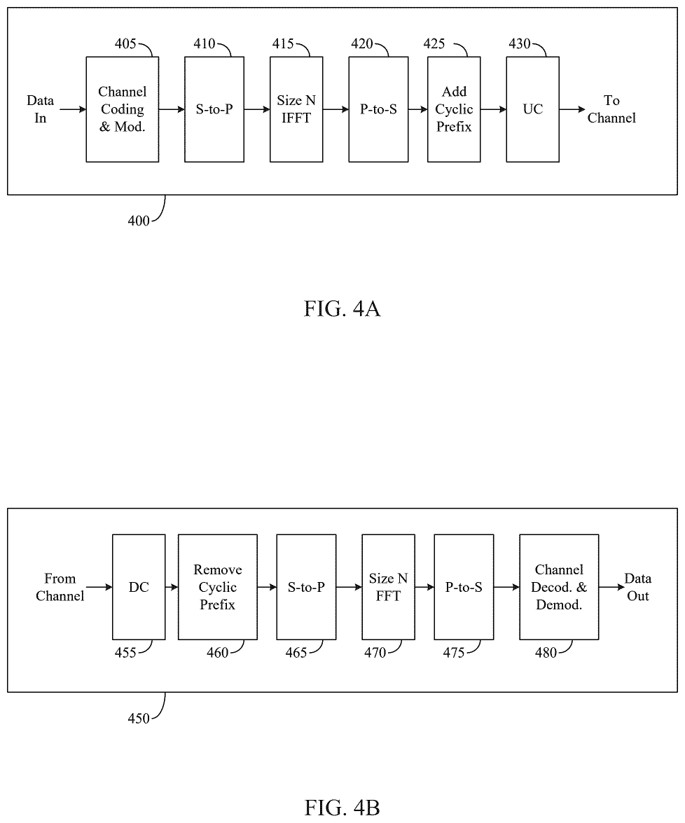

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the transmit path 400 is configured to support reduced blind decoding for DL control channels as described in embodiments of the present disclosure. In some embodiments, the receive path 450 is configured to support reduced blind decoding for DL control channels as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

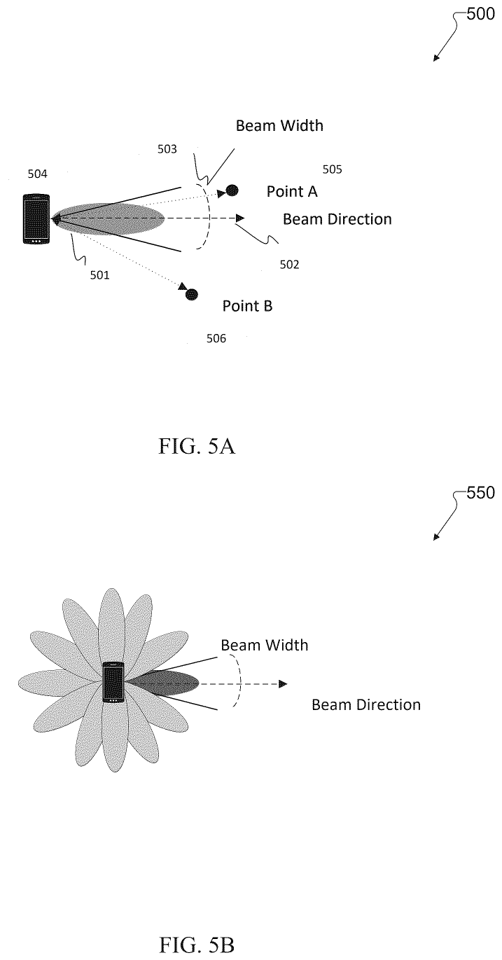

As illustrated in FIG. 5A, in a wireless system 500, a beam 501 for a device 504 can be characterized by a beam direction 502 and a beam width 503. For example, the device 504 (or UE 116) transmits RF energy in a beam direction and within a beam width. The device 504 receives RF energy in a beam direction and within a beam width. As illustrated in FIG. 5A, a device at point A 505 can receive from and transmit to device 504 as Point A is within a beam width and direction of a beam from device 504. As illustrated in FIG. 5A, a device at point B 506 cannot receive from and transmit to device 504 as Point B 506 is outside a beam width and direction of a beam from device 504. While FIG. 5A, for illustrative purposes, shows a beam in 2-dimensions (2D), it should be apparent to those skilled in the art, that a beam can be in 3-dimensions (3D), where the beam direction and beam width are defined in space.

FIG. 5B illustrates an example of a multi-beam operation 550 according to embodiments of the present disclosure. For example, the multi-beam operation 550 can be utilized by UE 116 of FIG. 3. This example is for illustration only and other embodiments can be used without departing from the scope of the present disclosure.

In a wireless system, a device can transmit and/or receive on multiple beams. This is known as “multi-beam operation”. While FIG. 5B, for illustrative purposes, a beam is in 2D, it should be apparent to those skilled in the art, that a beam can be 3D, where a beam can be transmitted to or received from any direction in space.

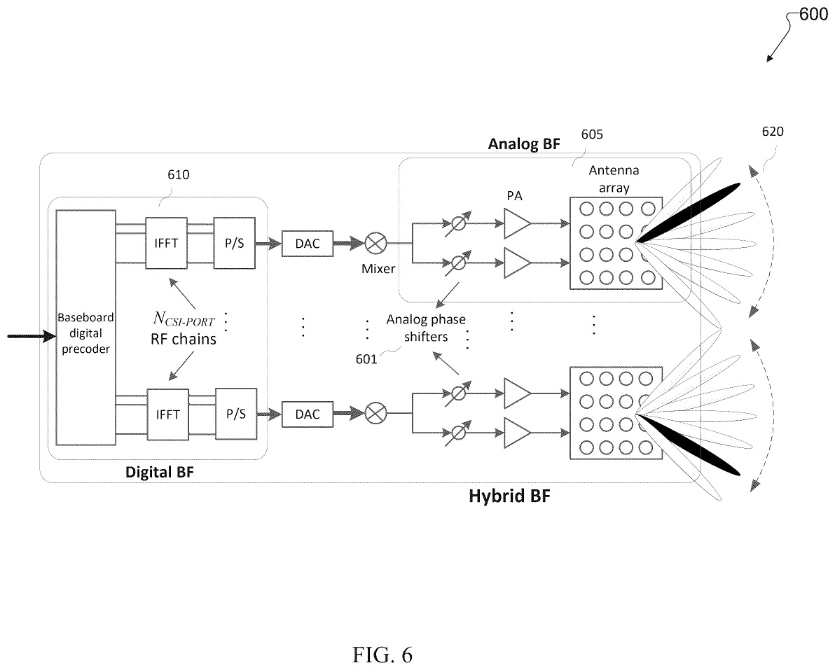

FIG. 6 illustrates an example of a transmitter structure 600 for beamforming according to embodiments of the present disclosure. In certain embodiments, one or more of gNB 102 or UE 116 includes the transmitter structure 600. For example, one or more of antenna 205 and its associated systems or antenna 305 and its associated systems can be included in transmitter structure 600. This example is for illustration only and other embodiments can be used without departing from the scope of the present disclosure.

Accordingly, embodiments of the present disclosure recognize that Rel-14 LTE and Rel-15 NR support up to 32 channel state indication refence signal (CSI-RS) antenna ports which enable an eNB or a gNB to be equipped with a large number of antenna elements (such as 64 or 128). A plurality of antenna elements can then be mapped onto one CSI-RS port. For mmWave bands, although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mmWave frequencies) as illustrated in FIG. 6. Then, one CSI-RS port can be mapped onto a large number of antenna elements that can be controlled by a bank of analog phase shifters 601. One CSI-RS port can then correspond to one sub-array which produces a narrow analog beam through analog beamforming 605. This analog beam can be configured to sweep across a wider range of angles 620 by varying the phase shifter bank across symbols or slots/subframes. The number of sub-arrays (equal to the number of RF chains) is the same as the number of CSI-RS ports N_{CSI-PORT}. A digital beamforming unit 610 performs a linear combination across N_{CSI-PORT} analog beams to further increase a precoding gain. While analog beams are wideband (hence not frequency-selective), digital precoding can be varied across frequency sub-bands or resource blocks. Receiver operation can be conceived analogously.

Since the transmitter structure 600 of FIG. 6 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam. The system of FIG. 6 is also applicable to higher frequency bands such as >52.6 GHz. In this case, the system can employ only analog beams. Due to the O2 absorption loss around 60 GHz frequency (˜10 dB additional loss per 100 m distance), a larger number and narrower analog beams (hence a larger number of radiators in the array) are needed to compensate for the additional path loss.

A time unit for DL signaling, for UL signaling, or for sidelink (SL) signaling on a cell is one symbol. A symbol belongs to a slot that includes a number of symbols such as 14 symbols. A slot can also be used as a time unit. A bandwidth (BW) unit is referred to as a resource block (RB). One RB includes a number of sub-carriers (SCs). For example, a slot can have duration of one millisecond and an RB can have a bandwidth of 180 kHz and include 12 SCs with inter-SC spacing of 15 kHz. As another example, a slot can have a duration of 0.25 milliseconds and include 14 symbols and an RB can have a BW of 720 kHz and include 12 SCs with SC spacing of 60 kHz. An RB in one symbol of a slot is referred to as physical RB (PRB) and includes a number of resource elements (REs). A slot can be either full DL slot, or full UL slot, or hybrid slot similar to a special subframe in time division duplex (TDD) systems (see also REF 1). A slot can include sub-band full duplex (SBFD) symbols, wherein a symbol includes DL sub-band(s) and UL sub-band(s). In addition, a slot can have symbols for SL communications. A UE can be configured one or more bandwidth parts (BWPs) of a system BW for transmissions or receptions of signals or channels.

DL signals include data signals conveying information content, control signals conveying DL control information (DCI), and reference signals (RS) that are also known as pilot signals. A gNB transmits data information or DCI through respective physical DL shared channels (PDSCHs) or physical DL control channels (PDCCHs). A PDSCH or a PDCCH can be transmitted over a variable number of slot symbols including one slot symbol. For brevity, a DCI format scheduling a PDSCH reception by a UE is referred to as a DL DCI format and a DCI format scheduling a physical uplink shared channel (PUSCH) transmission from a UE is referred to as an UL DCI format. A DCI format scheduling PDSCH reception or PUSCH transmission for a single UE, such as a DCI format with cyclic redundancy check (CRC) scrambled by cell RNTI (C-RNTI)/configured scheduling RNTI (CS-RNTI)/modulation and coding scheme (MCS)-C-RNTI as described in [REF 2], are referred for brevity as a unicast DCI format. A DCI format scheduling PDSCH reception for multicast communication, such as a DCI format with CRC scrambled by group RNTI (G-RNTI)/G-CS-RNTI as described in [REF 2], are referred to as multicast DCI format. DCI formats providing various control information to at least a subset of UEs in a serving cell, such as DCI format 2_0 in [REF 2], are referred to as group-common (GC) DCI formats.

The downlink physical-layer processing of transport channels on PDSCH can include the following steps: (1) Transport block CRC attachment; (2) Code block segmentation and code block CRC attachment; (3) Channel coding: LDPC coding; (4) Physical-layer hybrid-ARQ processing; (5) Rate matching; (6) Scrambling; (7) Modulation: QPSK, 16QAM, 64QAM, 256QAM, and 1024QAM; (8) Layer mapping; and (9) Mapping to assigned resources and antenna ports.

As mentioned herein, the Physical Downlink Control Channel (PDCCH) can be used to schedule DL transmissions on PDSCH and UL transmissions on PUSCH, where the Downlink Control Information (DCI) on PDCCH includes: (1) Downlink assignments containing at least modulation and coding format, resource allocation, and hybrid-ARQ information related to DL-SCH; and (2) Uplink scheduling grants containing at least modulation and coding format, resource allocation, and hybrid-ARQ information related to UL-SCH. In addition to scheduling, PDCCH can be used to for: (1) Activation and deactivation of configured PUSCH transmission with configured grant; (2) Activation and deactivation of PDSCH semi-persistent transmission; (3) Notifying one or more UEs of the slot format; (4) Notifying one or more UEs of the RB(s) and OFDM symbol(s) where the UE may assume no transmission is intended for the UE; (5) Transmission of transmit power control (TPC) commands for physical UL control channel (PUCCH) and PUSCH; (6) Transmission of one or more TPC commands for sounding reference signal (SRS) transmissions by one or more UEs; (7) Switching a UE's active bandwidth part; (8) Initiating a random access procedure; (9) Indicating the UE(s) to monitor the PDCCH during the next occurrence of the DRX on-duration; (10) In integrated access and backhaul (IAB) context, indicating the availability for soft symbols of an IAB-DU; (11) Triggering one shot HARQ-ACK codebook feedback; and (11) For operation with shared spectrum channel access: (11a) Triggering search space set group switching; (11b) Indicating one or more UEs about the available RB sets and channel occupancy time duration; and (11c) Indicating downlink feedback information for configured grant PUSCH (CG-DFI). Polar coding is used for PDCCH. QPSK modulation is used for PDCCH.

A UE monitors a set of PDCCH candidates in the configured monitoring occasions in one or more configured COntrol REsource SETs (CORESETs) according to the corresponding search space configurations.

A set of PDCCH candidates for a UE to monitor is defined in terms of PDCCH search space sets. A search space set can be a CSS set or a USS set. A UE monitors PDCCH candidates in one or more of the following search spaces set types: (1) a Type0-PDCCH CSS set on the primary cell of the MCG; (2) a Type0A-PDCCH CSS set on the primary cell of the MCG; (3) a Type0B-PDCCH CSS set; (4) a Type1-PDCCH CSS set on the primary cell; (5) a Type1A-PDCCH CSS set on the primary cell; (6) a Type2-PDCCH CSS set on the primary cell of the MCG; (7) a Type2A-PDCCH CSS set on the primary cell of the MCG; (8) a Type3-PDCCH CSS set and (9) a USS set. The configuration of a search space set provides: (1) searchSpaceId to identify the search; (2) controlResourceSetId providing the CORESET associated with the search space; (3) monitoring slot periodicity and offset; (4) duration providing a number of consecutive slots that a SearchSpace lasts in every occasion, i.e., upon every period as given in the periodicityAndOffset; (5) monitoringSymbolsWithinSlot providing the first symbol(s) for PDCCH monitoring in the slots configured for (multi-slot) PDCCH monitoring (see monitoringSlotPeriodicityAndOffset and duration); (6) number of candidates for each aggregation level; and (7) search space type according to one of the search space types mentioned herein.

For a search space set s associated with CORESET p, the CCE indexes for aggregation level L corresponding to PDCCH candidate

$${m}_{s , {n}_{CI}}^{( L )}$$

of the search space set in slot

$${n}_{s , f}^{μ}$$

for an active DL BWP of a serving cell corresponding to carrier indicator field value n_{CI}, or corresponding to value n_{CI} of nCI-Value associated with a set of serving cells MC-DCI-SetofCells, are given by (a hash function):

$$L \cdot \{ ( {Y}_{p , {n}_{s , f}^{μ}} + ⌊ \frac{{m}_{s , {n}_{CI}}^{( L )} \cdot {N}_{CCE , p}}{L \cdot {M}_{s , max}^{( L )}} ⌋ + {n}_{CI} ) mod ⌊ {N}_{CCE , p} / L ⌋ \} + i$$

where
for any CSS,

$${Y}_{p , {n}_{s , f}^{μ}} = 0 ;$$

for a USS,

$${Y}_{p , {n}_{s , f}^{μ}} = ( {A}_{p} \cdot {Y}_{p , {n}_{s , f}^{μ} - 1} ) mod D ,$$

Y_{p,-1}=n_{RNTI}≠0, Aₚ=39827 for pmod3=0, A_{P}=39829 for pmod3=1, Aₚ=39839 for pmod3=2, and D=65537;
i=0, . . . , L−1;
N_{CCE,p} is the number of CCEs, numbered from 0 to N_{CCE,p}−1, in CORESET p and, if any, per RB set
   for CORESET 0, the CCEs are obtained prior to puncturing, if any, of corresponding RBs [REF 1];
n_{CI} is
   the carrier indicator field value, if provided by cif-InSchedulingCell in CrossCarrierSchedulingConfig for the serving cell on which PDCCH is monitored, except for scheduling of the serving cell from the same serving cell in which case n_{CI}=0;
   the nCI-Value provided for the set of serving cells MC-DCI-SetofCells, if MC-DCI-SetofCells is provided;
   otherwise, including for any CSS, n_{CI}=0

$${m}_{s , {n}_{CI}}^{( L )} = 0 , … , {M}_{s , {n}_{CI}}^{( L )} - 1 , where {M}_{s , {n}_{CI}}^{( L )}$$

is the number of PDCCH candidates the UE is configured to monitor for aggregation level L of a search space set s for a serving cell corresponding to n_{CI};
for any CSS,

$${M}_{s , max}^{( L )} = {M}_{s , 0}^{( L )} ;$$

for a USS,

$${M}_{s , max}^{( L )}$$

is the maximum of

$${M}_{s , {n}_{CI}}^{( L )}$$

over configured n_{CI} values for a CCE aggregation level L of search space set s.

The UE's processing capability limits the number of blind decodes and CCEs for channel estimation depending on the sub-carrier spacing. Table 1 provides the maximum number

$${M}_{PDCCH}^{max , slot , μ}$$

of monitored PDCCH candidates per slot for a DL BWP with SCS configuration μ∈{0,1,2,3} for a single serving cell. Table 2 provides the maximum number

$${C}_{PDCCH}^{max , slot , μ}$$

of non-overlapped CCEs per slot for a DL BWP with SCS configuration μ∈{0,1,2,3} for a single serving cell.

TABLE 1

| | Maximum number of monitored PDCCH candidates per slot and per |
|---|---|
| μ | $serving cell {M}_{PDCCH}^{max , slot , μ}$ |
| 0 | 44 |
| 1 | 36 |
| 2 | 22 |
| 3 | 20 |

TABLE 2

| | Maximum number of non-overlapped CCEs per slot and per serving |
|---|---|
| μ | $cell {C}_{PDCCH}^{max , slot , μ}$ |
| 0 | 56 |
| 1 | 56 |
| 2 | 48 |
| 3 | 32 |

A CORESET includes: A set of RBs provided by higher layer parameter frequencyDomainResources, which is a bitmap where each bit corresponds to a group of resource blocks (RBs) (e.g., with 6 RBs per group), the number of RBs is denoted as

$${N}_{RB}^{CORESET} ,$$

with a time duration of 1 to 3 OFDM symbols provided by higher parameter duration,

$${N}_{s y m b}^{CORESET} .$$

The resource units Resource Element Groups (REGs) and Control Channel Elements (CCEs) are defined within a CORESET with each CCE including a set of REGs. Control channels are formed by aggregation of CCE. Different code rates for the control channels are realized by aggregating different number of CCE. Interleaved and non-interleaved CCE-to-REG mapping are supported in a CORESET configured by cce-REG-MappingType. The cce-REG-MappingType, can be (1) interleaved, and provides configuration parameters: (1a) reg-BundleSize L, where L∈{2,6}, if

$${N}_{symb}^{CORESET} = 1 and L ∈ \{ {N}_{symb}^{CORESET} , 6 \} , if {N}_{symb}^{CORESET} = 2 , 3 ;$$

(2a) interleaverSize R∈{2,3,6}; and (3a) shiftIndex n_{shift}∈{0,1,2, . . . , 274}, if provided otherwise

$${n}_{s hift} = {N}_{ID}^{cell} ;$$

or (2) non-interleaved, in which there is no interleaving and L=6.

The number of REGs in a CORESET is

$${N}_{REG}^{CORESET} = {N}_{symb}^{CORESET} \cdot {N}_{RB}^{CORESET .}$$

A REG bundle i is defined as REGs: {iL, iL+1, . . . , iL+L−1}, where i=0, 1, . . . ,

$${N}_{REG}^{CORESET} / L - 1 .$$

CCE j includes REG bundles {f(6j/L), (6j/L+1), . . . , (6j/L+6/L−1)}. Each resource element group carrying PDCCH carries its own demodulation reference signal (DMRS).

For interleaved CCE to REG mapping:

$$f ( x ) = ( r C + c + {n}_{s hift} ) mod ( {N}_{REG}^{CORESET} / L ) ,$$

where x=cR+r, r=0, 1, . . . , R−1 and c=0, 1, . . . , C−1. For non-interleaved CCE to REG mapping: f(x)=x.

For both interleaved and non-interleaved mapping: if the higher-layer parameter precoderGranularity equals sameAsREG-bundle the UE may assume the same precoding being used within a REG bundle. If the higher-layer parameter precoderGranularity equals allContiguousRBs: (1) the UE may assume the same precoding being used across the resource-element groups within the set of contiguous resource blocks in the CORESET, (2) the UE may assume that no resource elements in the CORESET overlap with a synchronization signal block (SSB), and if the UE is not provided with the higher-layer parameter pdcchCandidateReception-WithCRSOverlap, the UE may assume that no resource elements in the CORESET overlap with LTE cell-specific reference signals as indicated by the higher-layer parameter lte-CRS-ToMatchAround, lte-CRS-PatternList1, lte-CRS-PatternList2, lte-CRS-PatternList3, or lte-CRS-PatternList4.

The PDCCH repetition is operated by using two search spaces which are explicitly linked by configuration provided by the RRC layer, and are associated with corresponding CORESETs. For PDCCH repetition, two linked search spaces are configured with the same number of candidates, and two PDCCH candidates in two search spaces are linked with the same candidate index. When PDCCH repetition is scheduled to a UE, an intra-slot repetition is allowed and each repetition has the same number of CCEs and coded bits, and corresponds to the same DCI payload.

There are two different operation modes for multi-TRP PDCCH: PDCCH repetition as mentioned herein and Single Frequency Network (SFN) based PDCCH transmission. In both modes, the UE can receive two PDCCH transmissions, one from each TRP, carrying the same DCI. In PDCCH repetition mode, the UE can receive the two PDCCH transmissions carrying the same DCI from two linked search spaces each associated with a different CORESET. In SFN based PDCCH transmission mode, the UE can receive the two PDCCH transmissions carrying the same DCI from a single search space/CORESET using different transmission configuration indication (TCI) states.

A UE can be indicated a spatial setting for a PDCCH reception based on a configuration of a value for a transmission configuration indication state (TCI state) of a control resource set (CORESET) where the UE receives the PDCCH. The UE can be indicated a spatial setting for a PDSCH reception based on a configuration by higher layers or based on an indication by a DCI format scheduling the PDSCH reception of a value for a TCI state. The gNB can configure the UE to receive signals on a cell within a DL bandwidth part (BWP) of the cell DL BW.

A gNB (such as BS 102) transmits one or more of multiple types of RS including channel state information RS (CSI-RS) and demodulation RS (DMRS). A CSI-RS is primarily intended for UEs to perform measurements and provide channel state information (CSI) to a gNB. For channel measurement, non-zero power CSI-RS (NZP CSI-RS) resources are used. For interference measurement reports (IMRs), CSI interference measurement (CSI-IM) resources associated with a zero power CSI-RS (ZP CSI-RS) configuration are used. A CSI process includes NZP CSI-RS and CSI-IM resources. A UE (such as UE 116) can determine CSI-RS transmission parameters through DL control signaling or higher layer signaling, such as radio resource control (RRC) signaling from a gNB. Transmission instances of a CSI-RS can be indicated by DL control signaling or configured by higher layer signaling. A DMRS is transmitted only in the BW of a respective PDCCH or PDSCH and a UE can use the DMRS to demodulate data or control information.

UL signals also include data signals conveying information content, control signals conveying UL control information (UCI), DMRS associated with data or UCI demodulation, sounding RS (SRS) enabling a gNB to perform UL channel measurement, and a random access (RA) preamble enabling a UE to perform random access. A UE transmits data information or UCI through a respective physical UL shared channel (PUSCH) or a physical UL control channel (PUCCH). A PUSCH or a PUCCH can be transmitted over a variable number of slot symbols including one slot symbol. The gNB can configure the UE to transmit signals on a cell within an UL BWP of the cell UL BW.

UCI includes hybrid automatic repeat request acknowledgement (HARQ-ACK) information, indicating correct or incorrect detection of data transport blocks (TBs) in a PDSCH, scheduling request (SR) indicating whether a UE has data in the buffer of UE, link recovery request (LRR) for beam failure recovery, CSI reports enabling a gNB to select appropriate parameters for PDSCH or PDCCH transmissions to a UE, and UE initiated resource indicator (UEI-RI) indicating a request to transmit a UE initiated measurement report. HARQ-ACK information can be configured to be with a smaller granularity than per TB and can be per data code block (CB) or per group of data CBs where a data TB includes a number of data.

A CSI report from a UE can include a channel quality indicator (CQI) informing a gNB of a largest modulation and coding scheme (MCS) for the UE to detect a data TB with a predetermined block error rate (BLER), such as a 10% BLER, of a precoding matrix indicator (PMI) informing a gNB how to combine signals from multiple transmitter antennas in accordance with a multiple input multiple output (MIMO) transmission principle, and of a rank indicator (RI) indicating a transmission rank for a PDSCH. UL RS includes DMRS and SRS. DMRS is transmitted only in a BW of a respective PUSCH or PUCCH transmission. A gNB can use a DMRS to demodulate information in a respective PUSCH or PUCCH. SRS is transmitted by a UE to provide a gNB with an UL CSI and, for a TDD system, an SRS transmission can also provide a PMI for DL transmission. Additionally, in order to establish synchronization or an initial higher layer connection with a gNB, a UE can transmit a physical random-access channel (PRACH).

An antenna port is defined such that the channel over which a symbol on the antenna port is conveyed can be inferred from the channel over which another symbol on the same antenna port is conveyed.

For DM-RS associated with a PDSCH, the channel over which a PDSCH symbol on one antenna port is conveyed can be inferred from the channel over which a DM-RS symbol on the same antenna port is conveyed only if the two symbols are within the same resource as the scheduled PDSCH, in the same slot, and in the same precoding resource block group (PRG).

For DM-RS associated with a PDCCH, the channel over which a PDCCH symbol on one antenna port is conveyed can be inferred from the channel over which a DM-RS symbol on the same antenna port is conveyed only if the two symbols are within resources for which the UE may assume the same precoding being used.

For DM-RS associated with a physical broadcast channel (PBCH), the channel over which a PBCH symbol on one antenna port is conveyed can be inferred from the channel over which a DM-RS symbol on the same antenna port is conveyed only if the two symbols are within a synchronization signal/physical broadcast channel (SS/PBCH) block transmitted within the same slot, and with the same block index.

Two antenna ports are said to be quasi co-located if the large-scale properties of the channel over which a symbol on one antenna port is conveyed can be inferred from the channel over which a symbol on the other antenna port is conveyed. The large-scale properties include one or more of delay spread, Doppler spread, Doppler shift, average gain, average delay, and spatial Rx parameters.

The UE (such as the UE 116) may assume that synchronization signal (SS)/PBCH block (also denoted as SSBs) transmitted with the same block index on the same center frequency location are quasi co-located with respect to Doppler spread, Doppler shift, average gain, average delay, delay spread, and, when applicable, spatial Rx parameters. The UE may not assume quasi co-location for any other synchronization signal SS/PBCH block transmissions.

In absence of CSI-RS configuration, and unless otherwise configured, the UE may assume PDSCH DM-RS and SSB to be quasi co-located with respect to Doppler shift, Doppler spread, average delay, delay spread, and, when applicable, spatial Rx parameters. The UE may assume that the PDSCH DM-RS within the same code division multiplexing (CDM) group is quasi co-located with respect to Doppler shift, Doppler spread, average delay, delay spread, and spatial Rx. The UE may also assume that DM-RS ports associated with a PDSCH are quasi co-location (QCL) with QCL type A, type D (when applicable) and average gain. The UE may further assume that no DM-RS collides with the SS/PBCH block.

The UE can be configured with a list of up to M transmission configuration indication (TCI) State configurations within the higher layer parameter PDSCH-Config to decode PDSCH according to a detected PDCCH with DCI intended for the UE and the given serving cell, where M depends on the UE capability maxNumberConfiguredTCIstatesPerCC. Each TCI-State contains parameters for configuring a quasi-colocation (QCL) relationship between one or two downlink reference signals and the DM-RS ports of the PDSCH, the DM-RS port of PDCCH or the CSI-RS port(s) of a CSI-RS resource.

The quasi-co-location relationship is configured by the higher layer parameter qcl-Type1 for the first DL RS, and qcl-Type2 for the second DL RS (if configured). For the case of two DL RSs, the QCL types may not be the same, regardless of whether the references are to the same DL RS or different DL RSs. The quasi-co-location types corresponding to each DL RS are given by the higher layer parameter qcl-Type in QCL-Info and may take one of the following values: QCL-TypeA: {Doppler shift, Doppler spread, average delay, delay spread}; QCL-TypeB: {Doppler shift, Doppler spread}; QCL-TypeC: {Doppler shift, average delay}; and QCL-TypeD: {Spatial Rx parameter}.

The UE receives a MAC-CE activation command to map up to [N] (e.g., N=8) TCI states to the codepoints of the DCI field “Transmission Configuration Indication.” When the HARQ-ACK corresponding to the PDSCH carrying the activation command is transmitted in slot n, the indicated mapping between TCI states and codepoints of the DCI field “Transmission Configuration Indication” may be applied after a MAC-CE application time, e.g., starting from the first slot that is after slot

$$( n + 3 {N}_{slot}^{subframe , μ} ) .$$

In this disclosure, a beam can be determined by any of;
A TCI state, that establishes a quasi-colocation (QCL) relationship or spatial relation between a source reference signal (e.g. SSB and/or CSI-RS) and a target reference signal
A spatial relation information that establishes an association to a source reference signal, such as SSB or CSI-RS or SRS.

In either case, the ID of the source reference signal or TCI state or spatial relation identifies the beam.

The TCI state and/or the spatial relation reference RS can determine a spatial Rx filter for reception of downlink channels at the UE, or a spatial Tx filter for transmission of uplink channels from the UE. The TCI state and/or the spatial relation reference RS can determine a spatial Tx filter for transmission of downlink channels from the gNB (e.g., the BS 102), or a spatial Rx filter for reception of uplink channels at the gNB.

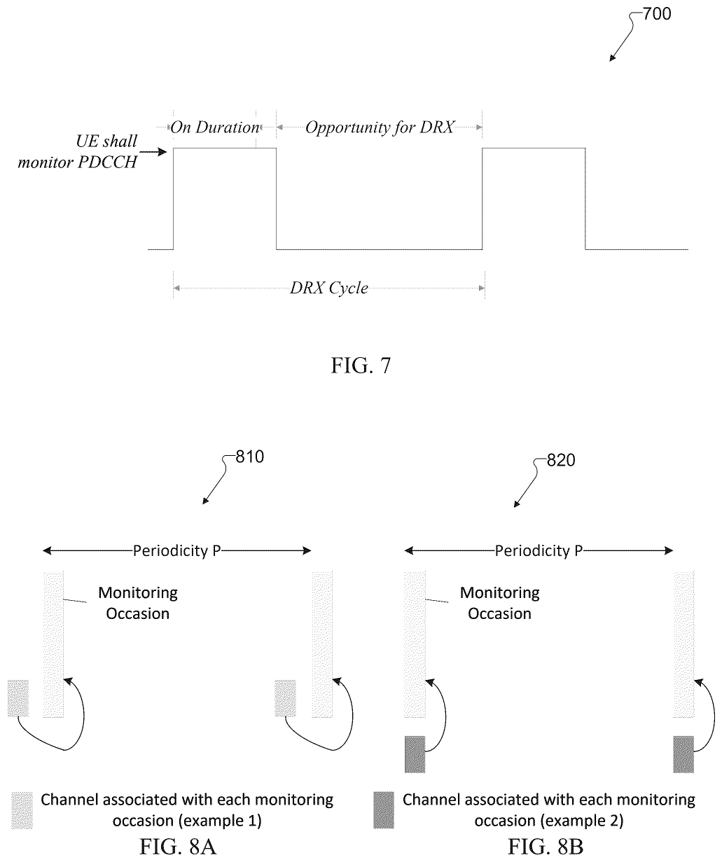

FIG. 7 illustrates an example DRX cycle 700 according to embodiments of the present disclosure. For example, DRX cycle 700 can be implemented in any of the UEs 111-116 of FIG. 1. This example is for illustration only and other embodiments can be used without departing from the scope of the present disclosure.

In NR, the blind decoding of PDCCH in each monitoring occasion can increase the UE's power consumption. To mitigate the increase, in UE's power consumption, NR introduced UE power saving mechanisms, whereby the PDCCH monitoring activity of the UE in RRC connected mode is governed by DRX, BA (bandwidth adaptation), DCP (DCI with CRC scrambled by power saving RNTI (PS-RNTI)) and cell discontinuous transmission (DTX).

When DRX is configured, the UE does not have to continuously monitor PDCCH. DRX is characterized by the following:
on-duration: duration that the UE waits for, after waking up, to receive PDCCHs. If the UE successfully decodes a PDCCH, the UE stays awake and starts the inactivity timer.
inactivity-timer: duration that the UE waits to successfully decode a PDCCH, from the last successful decoding of a PDCCH, failing which it can go back to sleep. The UE shall restart the inactivity timer following a single successful decoding of a PDCCH for a first transmission only (i.e. not for retransmissions).
retransmission-timer: duration until a retransmission can be expected.
cycle: specifies the periodic repetition of the on-duration followed by a period of inactivity. This is illustrated in FIG. 7.
active-time: total duration that the UE monitors PDCCH. This includes the “on-duration” of the DRX cycle, the time UE is performing continuous reception while the inactivity timer has not expired, and the time when the UE is performing continuous reception while waiting for a retransmission opportunity.

When BA is configured, the UE (e.g., the UE 116) only has to monitor PDCCH on the one active BWP i.e. it does not have to monitor PDCCH on the entire DL frequency of the cell. A BWP inactivity timer (independent from the DRX inactivity-timer described herein) is used to switch the active BWP to the default one: the timer is restarted upon successful PDCCH decoding and the switch to the default BWP takes place when it expires.

In addition, the UE may be indicated, when configured accordingly, whether it is required to monitor or not the PDCCH during the next occurrence of the on-duration by a DCP monitored on the active BWP. If the UE does not detect a DCP on the active BWP, it does not monitor the PDCCH during the next occurrence of the on-duration, unless it is explicitly configured to do so in that case. DCP is a DCI Format (DCI Format 2_6) with CRC scrambled by PS-RNTI which is used to determine if the UE needs to monitor PDCCH on the next occurrence of the connected mode DRX on-duration. One DCP can be configured to control PDCCH monitoring during on-duration for one or more UEs independently. A UE is allocated a block of bits in DCI Format 2_6, with one bit for wake-up indication, and up to 5 bits for SCell dormancy indication.

A UE can only be configured to monitor DCP when connected mode DRX is configured, and at occasion(s) at a configured offset before the on-duration. More than one monitoring occasion can be configured before the on-duration. The UE does not monitor DCP on occasions occurring during active-time, measurement gaps, BWP switching, or when it monitors response for a contention-free random access (CFRA) preamble transmission for beam failure recovery, in which case it monitors the PDCCH during the next on-duration. If no DCP is configured in the active BWP, UE follows normal DRX operation.

When CA is configured, DCP is only configured on the PCell.

Power saving in RRC_IDLE and RRC_INACTIVE can also be achieved by UE relaxing neighbor cells RRM measurements when it meets the criteria determining it is in low mobility and/or not at cell edge. When UE is configured with both high speed measurements and RRM measurement relaxation as specified in [REF 6], it is up to UE implementation whether to apply the FR1 high speed RRM requirements or the relaxed RRM requirements when the low mobility related criterion is configured and fulfilled as specified in TS 38.133.

UE power saving may be enabled by adapting the DL maximum number of MIMO layers by BWP switching.

Power saving is also enabled during active-time via cross-slot scheduling, which facilitates UE to achieve power saving with the assumption that it won't be scheduled to receive PDSCH, triggered to receive A-CSI or transmit a PUSCH scheduled by the PDCCH until the minimum scheduling offsets K0 and K2. Dynamic adaptation of the minimum scheduling offsets K0 and K2 is controlled by PDCCH.

Serving Cells of a MAC entity may be configured by RRC in two DRX groups with separate DRX parameters. When RRC does not configure a secondary DRX group, there is only one DRX group and Serving Cells belong to that one DRX group. When two DRX groups are configured, each Serving Cell is uniquely assigned to either of the two groups. The DRX parameters that are separately configured for each DRX group are on-duration and inactivity-timer.

UE power saving in RRC_IDLE/RRC_INACTIVE may be achieved by providing the configuration for tracking reference signal (TRS) with CSI-RS for tracking in TRS occasions. The TRS in TRS occasions may allow UEs in RRC_IDLE/RRC_INACTIVE to sleep longer before waking-up for its paging occasion. The TRS occasions configuration is provided in either SIB17 or SIB17bis. The availability of TRS in the TRS occasions is indicated by L1 availability indication. These TRSs may also be used by the UEs configured with eDRX.

UE power saving may be achieved by UE relaxing measurements for radio link monitoring (RLM)/beam failure detection (BFD). When configured, UE determines whether it is in low mobility state and/or whether its serving cell radio link quality is better than a threshold. The configuration for low mobility and good serving cell quality criterion is provided through dedicated RRC signaling.

RLM and BFD relaxation may be enabled/disabled separately through RRC Configuration. Additionally, RLM relaxation may be enabled/disabled on per Cell Group basis while BFD relaxation may be enabled/disabled on per serving cell basis.

The UE is only allowed to perform RLM and/or BFD relaxation when relaxed measurement criterion for low mobility and/or for good serving cell quality is met. If configured to do so, the UE shall trigger reporting of its RLM and/or BFD relaxation status through UE assistance information if the UE changes its respective RLM and/or BFD relaxation status while meeting the UE minimum requirements specified in TS 38.133.

UE power saving may also be achieved through PDCCH monitoring adaptation mechanisms when configured by the network (e.g., the network 130), including skipping of PDCCH monitoring and Search space set group (SSSG) switching. In this case UE does not monitor PDCCH during the PDCCH skipping duration except for the cases as specified in [REF 3], or monitors PDCCH according to the search space sets applied in SSSG.

In order to reduce UE power consumption due to false paging alarms, the group of UEs monitoring the same PO can be further divided into multiple subgroups. With subgrouping, a UE shall monitor PDCCH in its PO for paging if the subgroup to which the UE belongs is paged as indicated via associated PEI (Paging Early Indication). If a UE cannot find its subgroup ID with the PEI configurations in a cell or if the UE is unable to monitor the associated PEI occasion corresponding to its PO, it shall monitor the paging in its PO. A PEI is a DCI Format (DCI Format 2_7) with CRC scrambled by PEI-RNTI used to determine if the UE needs to monitor the associated PO.

The UE can signal the network through UEAssistanceInformation if it prefers certain DRX parameter values, and/or a reduced maximum number of secondary component carriers, and/or a reduced maximum aggregated bandwidth and/or a reduced maximum number of MIMO layers and/or minimum scheduling offsets K0 and K2 for power saving purpose.

In this disclosure a mechanism is provided whereby, a channel can be received by the UE that provides information about the PDCCH in a slot or in a monitoring occasion. The benefit of such a scheme is to limit the blind decoding performed by the UE, thus limiting the UE's power consumption. This channel, can be received by multiple UEs, providing for each UE information about the location of PDCCH channel(s) intended for the corresponding UE in a slot(s) or monitoring occasion(s).

As mentioned herein, in NR a UE is configured with search space sets and control resource sets (CORESETs) for the reception of downlink control channels (PDCCHs) carrying downlink control information (DCIs), whereby a search space set is linked to a CORESET and a UE monitors PDCCH candidates in the CORESETs according to the search space sets. The UE decodes DCIs for a number of PDCCH candidates in a monitoring occasion (MO) identified according to search space sets to determine if there are any PDCCH candidates intended for the UE in the MO. The determination is based on a positive or negative check of CRC bits masked with a radio network temporary identifier (RNTI) for the UE, wherein an RNTI is associated with a search space set and there can be multiple RNTIs configured for the UE for a same or for different search space sets. A hashing function, as mentioned herein, pseudo-randomly maps the PDCCH candidates of a search space set to CCEs of an associated CORESET. One of the motivations of the hashing function is to reduce a probability that different UEs have PDCCH candidates on same CCEs, such as for example sixteen CCEs being same for eight PDCCH candidates using two CCEs for a first UEs and for one PDCCH candidate using sixteen CCEs for a second UE. That probability is also referred to as blocking probability.

FIGS. 8A and 8B illustrate examples of PDCCH MOs 810 and 820 according to embodiments of the present disclosure. For example, PDCCH MOs 810 and 820 can be received by any of the UEs 111-116 of FIG. 1, such as the UE 111. This example is for illustration only and other embodiments can be used without departing from the scope of the present disclosure.

To limit a number of decoding operations for DCIs performed by a UE, the UE can be configured to receive a channel in respective MOs, or associated with respective MOs, such as for example a PDCCH according to a search space set, wherein the channel provides information for the PDCCH candidate(s) intended for the UE for a subsequent number of MOs. A serving gNB can configure a same channel to one or more UEs. FIG. 8(A) and FIG. 8(B), illustrate two examples, where a PDCCH MO has an associated channel (e.g., Channel A). The associated channel provides information about the PDCCH candidates for the PDCCH MO or for next one or more PDCCH MOs or, in general, for PDCCH MOs until a next MO for the channel or the next instance for the channel, and subject to the processing delay of the channel. For example, the information can include starting CCE of a PDCCH candidate, an aggregation level of the PDCCH candidate, the index of the PDCCH candidate, wherein the index can indicate a target of the PDCCH candidate, information related to the DCI format and/or a payload size for the PDCCH candidate, etc. The information can be for a UE, for example for a PDCCH candidate and for an index of an associated search space set, such as for example for a PDCCH candidate associated with a UE-specific search space set, or can be for an RNTI associated with a DCI format provided by the PDCCH candidate, such as for example for a PDCCH candidate associated with a common search space set, and for the index of the common search space set. In one example of FIG. 8(A), the associated channel (e.g., Channel A) does not overlap in time with the PDCCH MO, e.g., Channel A is before the PDCCH MO. In one example of FIG. 8(B), the associated channel (e.g., Channel A) overlaps in time with the PDCCH MO, e.g., Channel A is frequency division multiplexed with the PDCCH MO. In one example, Channel A is configured with its own MOs, that are separate from the associated PDCCH MOs. In one example, Channel A is included in the PDCCH MOs. In one example, Channel A is configured with time and frequency resources, e.g., based on an offset and a periodicity.

In one example, a UE is configured with:
1. A first number of CORESETs, such as two CORESETs
2. A second number of search space sets associated with the first number of CORESETs, such as 5 search space sets.
3. A channel (e.g., Channel A) associated with the second number of search space sets and/or the first number of CORESETs.

In one example, for a PDCCH MO according to a search space set, the UE is indicated the corresponding instance/MO of Channel A that provides information for one or more PDCCH candidates for the PDCCH MO.

In one example, after receiving information for the instance/MO of Channel A, the UE determines if there are any PDCCH candidates for the UE in PDCCH MOs corresponding to Channel A and the instance/MO for Channel A.

In one example, for PDCCH candidates intended to a UE, UE receives the PDCCH candidates on corresponding CCEs as indicated by Channel A.

In one example, Channel A can be referred to as physical downlink information channel (PDICH).

This disclosure provides the design and configuration of Channel A, the payload of Channel A, and UE procedures associated with the information provided by Channel A.

The present disclosure relates to a 5G/NR and/or 6G communication system.

This disclosure provides a signaling framework for downlink control information, where a channel (e.g., Channel A) provides information to one or more UEs about the PDCCH candidates monitored by the one or more UEs. A reception of the channel is associated with one or more MOs for the channel or instances of the channel. The MOs for the channel or instances of the channel can be configured to a UE or can be determined relative to MOs of the PDCCH candidates, such as by a time offset to the MOs of the PDCCH candidates including a time offset of zero. The MOs for the channel or the instances of the channel can be associated with a periodicity. The information provided by the channel can be for one or more of: (a) one or more CCE aggregation levels of PDCCH candidates, (b) one or more indexes of PDCCH candidates, (c) one or more indexes of search space sets to monitor PDCCH candidates. The MOs for the PDCCH candidates can be linked to the MOs of the channel or instances of the channel, such as for example the PDCCH MOs between two consecutive MOs for the channel or two consecutive instances of the channel. The PDCCH MOs associated with a MO for the channel or instance of the channel can be defined relative to a time offset from the MO of the channel or instance of the channel in order to provide a UE sufficient processing time for the information provided by the channel. The processing time can be defined in the specifications of the system operation or can be a UE capability that is indicated by the UE to the serving gNB. This disclosure provides:
The design and configuration of Channel A.
Payload of Channel A.
UE procedures associated with information provided by Channel A.

In the following, both frequency division duplexing (FDD) and time division duplexing (TDD) are regarded as a duplex method for DL and UL signaling. In addition, full duplex (XDD) operation can be provided, e.g., sub-band full duplex (SBFD) or single frequency full duplex (SFFD).

Although exemplary descriptions and embodiments to follow expect orthogonal frequency division multiplexing (OFDM) or orthogonal frequency division multiple access (OFDMA), this disclosure can be extended to other OFDM-based transmission waveforms or multiple access schemes such as filtered OFDM (F-OFDM).

This disclosure provides several components that can be used in conjunction or in combination with one another, or can operate as standalone schemes.

In this disclosure, RRC signaling (e.g., configuration by RRC signaling) includes (1) common information provided by common signaling, e.g., this can be system information block (SIB)-based signaling (e.g., SIB1 or other SIB) or (2) RRC dedicated signaling that is sent to a specific UE wherein the information can be common/cell-specific information or dedicated/UE-specific information or (3) UE-group-common RRC signaling.

In this disclosure MAC CE signaling can be UE-specific e.g., to one UE or can be UE common (e.g., to a group of UEs or to UEs in a cell). MAC CE signaling can be DL MAC CE signaling or UL MAC CE signaling.

In this disclosure L1 control signaling includes: (1) DL control information (e.g., DCI on PDCCH or DL control information on PDSCH) and/or (2) UL control information (e.g., UCI on PUCCH or PUSCH). L1 control signaling can be UE-specific e.g., to one UE, or can be UE common e.g., to a group of UEs or UEs in cell.

In this disclosure, configuration can refer to configuration by semi-static signaling (e.g., RRC or SIB signaling). In one example, a configuration can be applicable to multiple transmission instances, until a new configuration is received and applied.

In this disclosure, indication can refer to indication by dynamic signaling (e.g., L1 control (e.g., DCI Format) or MAC CE signaling). In one example, an indication can be for an associated occasion(s) (e.g., an occasion or multiple occasions associated with the indication).

In this disclosure a list with N elements can be denoted as L(i), where i can take N values, and L(i) can correspond to the element or entry associated with index i. In one example, i can take N arbitrary values. In one example, i=0, 1, . . . , N−1. In one example, i=1, 2, . . . , N. In one example, i is an identity of an element or entry in the list.

In the present disclosure, the term “activation” describes an operation wherein a UE receives and decodes first information provided by a first signal from the network (or gNB) and, based on the first information, the UE determines a starting point in time. The starting point can be a present or a future slot/subframe or symbol and the exact location is either implicitly or explicitly indicated, or is otherwise defined in the system operation or is configured by higher layers. Upon successfully decoding the first information, the UE responds according to an indication provided by the first information. The term “deactivation” describes an operation wherein a UE receives and decodes second information provided by a second signal from the network (or gNB) and, based on the second information from the signal, the UE determines a stopping point in time. The stopping point can be a present or a future slot/subframe or symbol and the exact location is either implicitly or explicitly indicated, or is otherwise defined in the system operation or is configured by higher layers. Upon successfully decoding the second information, the UE responds according to an indication provided by the second information. The first signal can be same as the second signal or the first information can be same as the second information, wherein a first part of the information can be associated with an “activation” operation and with first UEs or with first parameters for transmissions/receptions by a UE, and a second part of the information can be associated with a “deactivation” operation and with second UEs or with second parameters for transmissions/receptions by the UE. For example, the second information can be absent, and deactivation can be implicitly derived. For example, when a UE has received an activation information in a previous indication, and is not included among UEs with activation information in a next indication, the UE can determine the latter indication as an implicit deactivation indication.

In this disclosure, a time unit, for example, can be a symbol or a slot or sub-frame or a frame. In one example, a time-unit can be multiple symbols, or multiple slots or multiple sub-frames or multiple frames. In one example, a time-unit can be a sub-slot (e.g., part of a slot). In one example, a time-unit can be specified in units of time, e.g., microseconds, or milliseconds or seconds, etc.

In this disclosure, a frequency-unit, for example, can be a sub-carrier or a resource block (RB) or a sub-channel, wherein a sub-channel is a group or RBs, or a bandwidth part (BWP). In one example, a frequency-unit can be multiple sub-carriers, or multiple RBs or multiple sub-channels. In one example, a frequency-unit can be a sub-RB (e.g., part of a RB). A frequency-unit can be specified in units of frequency, e.g., Hz, or kHz or MHz, etc.

Terminology such as search space, search space set, control resource set (CORESET), DCI Format, uplink control information (UCI), HARQ-ACK and other terms, is used for illustrative purposes and is therefore not normative. Other terms that refer to same functions can also be used.

In this disclosure, a search space set can be configured with multiple CCE aggregation levels for PDCCH candidates and with multiple PDCCH candidates per CCE aggregation level.

In one example, a UE is configured with one or more control resource sets (CORESET), wherein a CORESET configuration can provide some or all of the following information:
Control resource set identifier (ID). For example, Control resource set ID can identify a CORESET configuration, e.g., within serving cell. In one example, the ID space is used across the BWPs of a serving cell.
Duration, wherein the duration is the number of symbols or time units of a CORESET. In one example, a duration can be 1 symbol. In one example, a duration can be 2 symbols. In one example, a duration can be 3 symbols. In one example, a duration can be 4 symbols. In one example, a duration can be 5 symbols. In one example, a duration can be 6 symbols. In one example, a duration can be 7 symbols. In one example, a duration can be 8 symbols. In one example, a duration cab be a slot (e.g., 14 symbols).
Frequency domain resources. In one example, the frequency domain resources can be provided as a bitmap (e.g., bit map of groups of N RBs (or N frequency units), for example N can be 1 or N can be 6). In one example, the frequency domain resources can be provided as a starting location as a frequency unit and/or length in frequency units and/or ending location as a frequency unit. The grouping can start from the first RB group in the BWP where the CORESET is configured. In one example, the first or left-most or most-significant bit corresponds to the first RB group in the BWP. In one example, if a bit is set to “1”, the corresponding RB group belongs to the frequency domain resources of the CORESET.
RB offset, for example to indicate the RB (or frequency unit) level offset in units of RB (or frequency unit), or RB groups, from the first RB (or frequency unit) of the first N RB (or frequency unit) group to the first RB (or frequency unit) of BWP, for example N can be 1 or N can be 6.
CCE to REG mapping type, wherein the mapping type can be interleaved or non-interleaved.
Interleaver size as mentioned herein.
Shift index for interleaver as mentioned herein.
REG bundle size, the size of an REG bundle in RBs or frequency-units. In one example, for non-interleaved CCE to REG mapping the REG bundle size can be specified in the specification (e.g., 6 RBs).
Precoder granularity. In one example, the pre-coder granularity can be the same as a REG bundle. In one example, the pre-coder granularity can be across contiguous RBs of CORESET. In one example, the pre-coder granularity can be across RBs of CORESET.
TCI state, wherein the TCI state determines spatial domain filter of CORESET. In one example, a CORESET follows the unified or indicated or main TCI state. In one example, a CORESET configuration can include a flag to indicate whether or not the CORESET follows the unified or indicated or main TCI state. In one example, if a UE is indicated more than one TCI state (e.g., in case of multi-TRP), the CORESET configuration can include a flag to indicate which TCI state to follow, for example, in case of two indicated TCI states, the flag can be first or second or both or none.
PDCCH DMRS scrambling code ID.
CORESET Pool Index. In one example, the CORESET Pool Index can be associated with the TRP or the panel or the cell transmitting the CORESET.
Associated channels (e.g., Channel A) with a CORESET. This can include configuration information for Channel A and/or index to a Channel A configuration.

In one example, a UE is configured with one or more search space sets, wherein a search space set can be either UE-specific (USS set) or common (CSS set), and wherein a search space set configuration can provide the some or all of the following information:
Search space set identifier (ID). For example, search space set ID can identify a search space set configuration. In one example, the search space set ID is unique among BWPs of a serving cell.
Control resource set identifier (ID). In one example, this is the ID of a CORESET associated with a search space set. In a variant example, the some or all of the configuration parameters of a CORESET mentioned herein can be included in the search space set configuration.
Monitoring slot periodicity and offset. In one example, this can provide slots (or first slots of monitoring occasion for each period) configured for PDCCH monitoring as a periodicity and offset. In one example, slot can be replaced by time-unit. In one example, one offset value and one periodicity can be configured. In one example, multiple offset values can be configured for a same periodicity.
Duration of a monitoring occasion. In one example, the duration of a monitoring occasion is in slots. In one example, the duration of a monitoring occasion is in time-units. In one example, duration is a number of consecutive slots (or time-units) that a Search Space lasts in every periodic occasion, i.e., upon every period as given in the periodicity and offset. In one example, the duration can be provided by a bitmap of slots (or time-units) within the periodicity. In one example, a duration can be provided as a list of slots (or time-units) within the periodicity. In one example, a UE can be provided a periodicity in slots (or time-units) and a duration (e.g., a bitmap of slots (or time-units) within the periodicity, or a list of slots (or time-units) within the periodicity, or an offset in slots (or time-units) and a duration in slots (or time-units)). In one example, the duration is 1, e.g., one slot or one-time unit.
Monitoring slots within slot group. In one example, this parameter can indicate which slot(s) (or time-unit(s)) within a slot (or time-unit) group are configured for multi-slot (or multi-time-unit) PDCCH monitoring. The first (leftmost, most significant) bit represents the first slot (or time-unit) in the slot (or time-unit) group, the second bit represents the second slot (or time-unit) in the slot (or time-unit) group, and so on. A bit set to ‘1’ indicates that the corresponding slot (or time-unit) is configured for multi-slot (or multi-time-unit) PDCCH monitoring
Monitoring symbols within slot. In one example, this can indicate the first symbol(s) for PDCCH monitoring in the slots (or time-units) configured for PDCCH monitoring.
Number of PDCCH candidates. In one example, this is a list that indicates the number of PDCCH candidates per aggregation level. In one example, this is a list that indicates the number of PDCCH candidates per aggregation level per DCI Format (or payload size).
Search space set type. In one example, a search space set type can be one of the search space set types described herein. In one example, a search space set type can be a CSS set. In one example, a search space set type can be a USS set. In one example, a search space set type configuration can include a list of allowed DCI Formats associated with PDCCH candidates for the search space set. In one example, a search space set configuration can include a list of allowed payload size for the associated DCIs. In one example, the payload size of the DCIs for the search space set can be determined based on the DCI format and other configuration parameters that can determine a field size (including whether or not a field is present) in the DCI format.
List of aggregation levels. In one example, a code point can be mapped to each element in the list, for example code point 0 is mapped to the first aggregation level in the list, code point 1 is mapped to the second aggregation level in the list and so on. In one example, for a aggregation level, a UE (e.g., the UE 116) can be configured one or more of the following: (1) one or more DCI formats, (2) one or more payload sizes, and/or (3) a number of PDCCH candidates.
List of payload sizes. In one example, a code point can be mapped to each element in the list, for example code point 0 is mapped to the first payload size in the list, code point 1 is mapped to the second payload size in the list and so on. In one example, for a payload size, a UE can be configured one or more of the following: (1) one or more aggregation levels, and/or (2) a number of PDCCH candidates and/or (3) one or more DCI Formats. Examples of the use of this parameter is provided later in this disclosure.
List of DCI Formats. In one example, a code point can be mapped to each element in the list, for example code point 0 is mapped to the first DCI Format in the list, code point 1 is mapped to the second DCI Format in the list and so on. In one example, for a DCI format, a UE can be configured one or more of the following: (1) one or more aggregation levels, and/or (2) a number of PDCCH candidates and/or (3) one or more payload sizes. Example of the use of this parameter is provided later in this disclosure.
Search space set group list ID. In one example, search space set group list ID can provide a list of search space set group IDs which the search space set is associated with.
Frequency monitor locations. In one example, this parameter can define an association of the search space to multiple monitoring locations in the frequency domain and indicates whether the pattern configured in the associated CORESET is replicated to a specific RB set.
Search space set linking identity (ID). In one example, this parameter can provide linkage to multiple (e.g., two) search space sets. In one example, the linkage is within a BWP. In one example, if multiple (e.g., two) search space sets have the same search space set linking ID UE assumes these search space sets are linked to PDCCH repetition.
TCI state, e.g., if not included in an associated CORESET configuration, wherein the TCI state determines spatial domain filter for PDCCH receptions based on search space set. In one example, a search space set follows the unified or indicated or main TCI state. In one example, a search space set configuration can include a flag to indicate whether or not the search space set follows the unified or indicated or main TCI state. In one example, if a UE is indicated more than one TCI state (e.g., in case of multi-TRP), the search space set configuration can include a flag to indicate which TCI state to follow, for example, in case of two indicated TCI states, the flag can be first or second or both or none. In one example, if a configuration related to the TCI state is provided in the search space set configuration and in an associated CORESET configuration, the UE uses the configuration in the search space set configuration. In one example, if a configuration related to the TCI state is provided in the search space set configuration and in an associated CORESET configuration, the UE uses the configuration in the CORESET configuration. In one example, if a configuration related to the TCI state is provided in the search space set configuration and in an associated CORESET configuration, a UE is indicated or configured which configuration to use.
PDCCH DMRS scrambling code ID.
Associated channels (e.g., Channel A) with a search space set. In one example, the associated channels can provide information about the DCIs in corresponding (or associated) monitoring occasions of a search space set as described later in this disclosure. In one example, an association or linkage is provided to an associated channel configuration, the linkage can be explicit (e.g., by including an ID of an associated channel configuration), or implicit. In one example, an ID of an associated channel configuration can be included. In one example, the associated channel configuration parameters, as described later in this disclosure, or a subset of them, can be included. In one example, the linkage of Channel A to search space set configuration is provided in the Channel A configuration. In one example, the linkage of Channel A to search space set configuration is provided in the CORESET configuration associated with the search space set. In one example, Channel A is applicable to configuration of search space sets for a UE. In one example, Channel A has its own search space set, and MOs, an association or linkage between the search space set and/or MOs of Channel A and the search space set and/or MOs of the PDCCH candidates is provided. In one example, if a configuration related Channel A is provided in the search space set configuration and in an associated CORESET configuration, the UE uses the configuration in the search space set configuration. In one example, if a configuration related to Channel A is provided in the search space set configuration and in an associated CORESET configuration, the UE uses the configuration in the CORESET configuration. In one example, if a configuration related to Channel A is provided in the search space set configuration and in an associated CORESET configuration, a UE is indicated or configured which configuration to use.

In one example, as mentioned herein, a channel (referred to as Channel A) is associated with one or more search space sets, wherein the channel provides information about DCI(s) and/or PDCCH candidate(s) in corresponding or associated MOs and/or CCEs for the one or more search space sets.

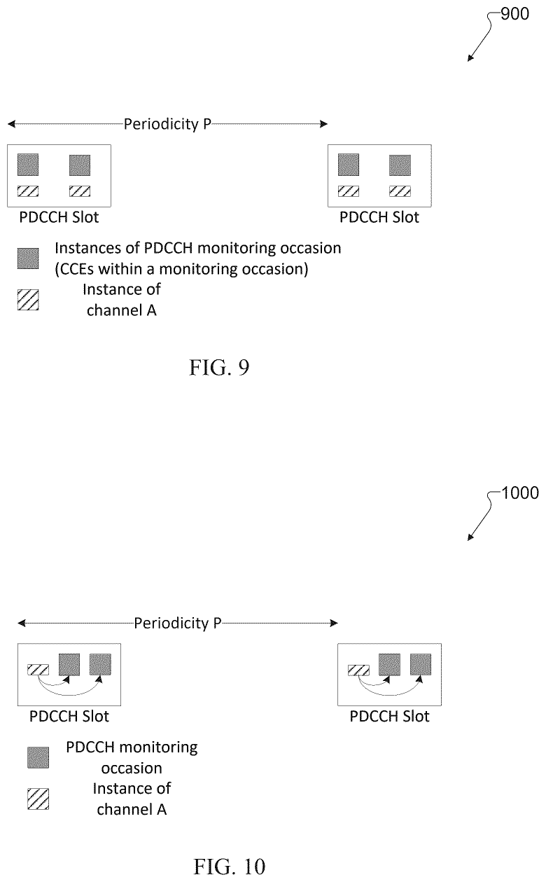

FIG. 9 illustrates an example periodicity 900 for a PDCCH slot according to embodiments of the present disclosure. For example, periodicity 900 for a PDCCH slot can be monitored by any of the UEs 111-116 of FIG. 1, such as the UE 112. This example is for illustration only and other embodiments can be used without departing from the scope of the present disclosure.

In one example, an instance/MO of Channel A is associated with one or more PDCCH MOs for one or more search space sets configured to a UE. This is illustrated in FIG. 9. In this example, a PDCCH MO in a CORESET refers to one or more sets of symbols corresponding to respective one or more CORESETs (e.g., as provided by the duration parameter of a CORESET configuration) where the UE receives PDCCH candidates and subsequently decodes for DCIs associated with the one or more search space sets. In the example, of FIG. 9, a slot includes two PDCCH MOs for a UE, as determined by the configuration of search space sets for the UE, and each PDCCH MO has an associated instance/MO of Channel A, wherein Channel A provides information about PDCCH candidates and associated DCIs in the corresponding/associated PDCCH MO. The search space sets of FIG. 9 are configured with a periodicity of P slots and a slot with PDCCH MOs occurs every period of P slots. A slot with PDCCH MOs can have an offset within the periodicity P (e.g., relative to system frame number (SFN) #0). This is not shown in FIG. 9. In the example of FIG. 9, the instance of Channel A and the associated CORESET or PDCCH MO overlap in time (e.g., they can be frequency division multiplexed). Alternatively, they can partially overlap in some symbols. In a variant example, the instance/MO of Channel A and the associated CORESET or PDCCH MO can occur in non-overlapping time periods, for example an instance/MO of Channel A occurs first followed by an associated PDCCH MO as illustrated in example 1 of FIG. 8(A). An application time for information provided by Channel A can be defined relative to the end of a reception for Channel A for a corresponding instance/MO. The application time can be defined in symbols or slot for a given SCS or in absolute time such as in milliseconds. The information provided by Channel A is applicable for PDCCH MOs of search space sets associated with Channel A that occur at or after the application time from the end of the Channel A reception, and that information can remain applicable until a next instance/MO for Channel A plus the application time. In another example, the information provided by Channel A remains applicable for an absolute time duration or a number of symbols or slots or a number of PDCCH MOs, as provided by higher layer configuration for Channel A or indicated within the Channel A payload.

FIG. 10 illustrates an example periodicity 1000 for a PDCCH slot according to embodiments of the present disclosure. For example, periodicity 1000 for a PDCCH slot can be monitored by any of the UEs 111-116 of FIG. 1, such as the UE 113. This example is for illustration only and other embodiments can be used without departing from the scope of the present disclosure.

In one example, an instance/MO of Channel A is associated with more than one PDCCH MOs of associated search space sets. In one example, in FIG. 10, a slot has two PDCCH MOs, and an instance/MO of Channel A is associated with the PDCCH MOs (e.g., 2 PDCCH MOs in FIG. 10). In the example of FIG. 10, Channel A has two associated PDCCH MOs in a slot. In a variant example, Channel A can be in a different slot than slots for PDCCH MOs. In either case, an application time (UE processing time) for information provided by Channel A can also apply for associated PDCCH MOs.

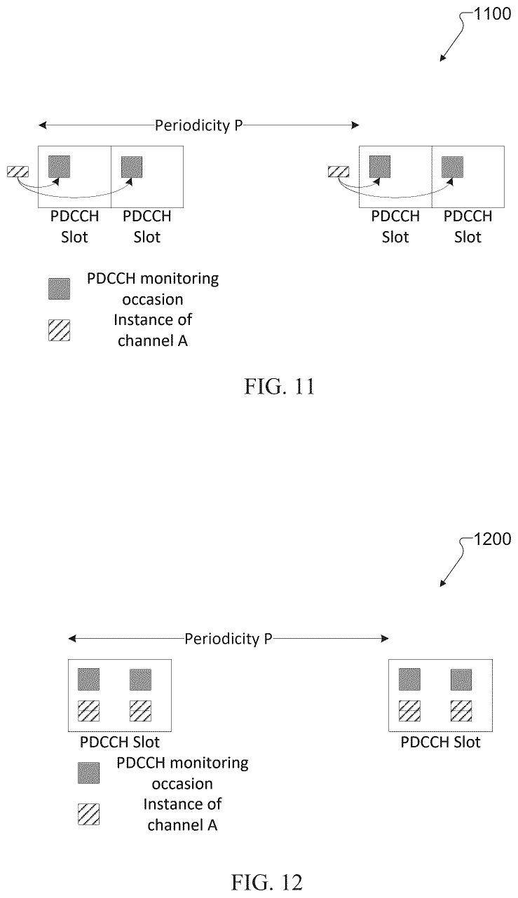

FIG. 11 illustrates an example periodicity 1100 for PDCCH slots according to embodiments of the present disclosure. For example, periodicity 1100 for PDCCH slots can be monitored by any of the UEs 111-116 of FIG. 1, such as the UE 114. This example is for illustration only and other embodiments can be used without departing from the scope of the present disclosure.

In one example, in FIG. 11, a search space set configuration has a duration of two slots, with PDCCH MOs occurring in two consecutive slots or non-consecutive slots, and an instance/MO of Channel A is associated with the PDCCH MOs (e.g., 2 PDCCH MOs in the example of FIG. 11). The association can repeat in time. For example, a next instance/MO of Channel A can be after two slots and information provided by Channel A can be applicable for PDCCH MOs in the next two slots. The association can also include an application time for information provided by Channel A and associated with the PDCCH MOs.

FIG. 12 illustrates an example periodicity 1200 for a PDCCH slot according to embodiments of the present disclosure. For example, periodicity 1200 for a PDCCH slot can be monitored by any of the UEs 111-116 of FIG. 1, such as the UE 115. This example is for illustration only and other embodiments can be used without departing from the scope of the present disclosure.

In one example, multiple instances/MOs of Channel A are associated with one PDCCH MO for a search space set. For example, if the payload of information provided by Channel A is too large to be provided in one instance/MO of Channel A, such as when a desired code rate for the information that is to be provided by Channel A cannot be achieved using time/frequency resources configured for Channel A, the payload can be partitioned across multiple instances/MOs of Channel A as illustrated in FIG. 12. For example, if same information is provided in the multiple instances/MOs of Channel A, a UE can combine the receptions of Channel A in the multiple instances/MOs to increase coverage or decoding reliability for the information provided by Channel A. In one example, Channel A is repeated multiple times with a same payload using different spatial domain transmission filters (e.g., different TCI states or different beam indications). In another example, channel A is repeated multiple times with a same payload using a same spatial domain transmission filter (e.g., a same TCI state or a same beam indication), such as to allow for beam sweeping at the UE to refine a UE DL Rx beam.

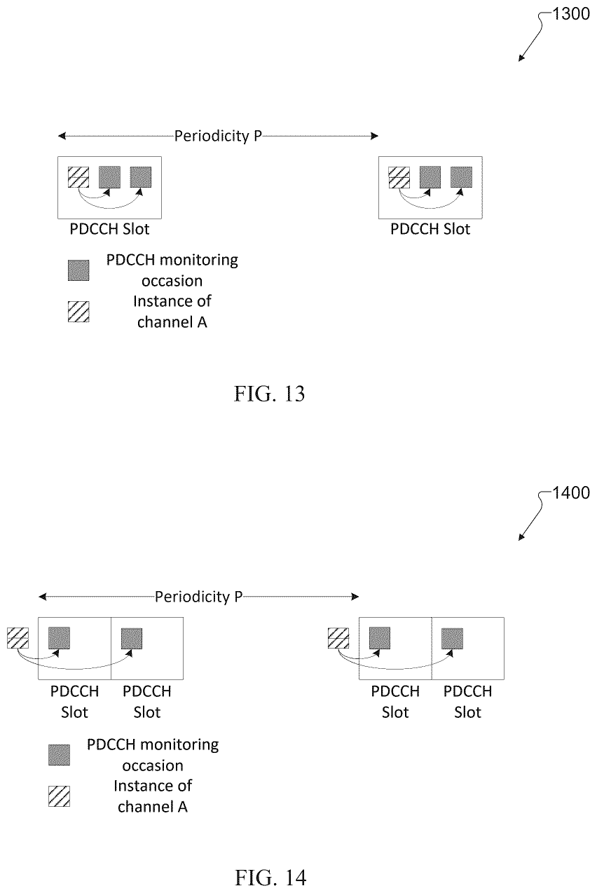

FIG. 13 illustrates an example periodicity 1300 for a PDCCH slot according to embodiments of the present disclosure. For example, periodicity 1300 for a PDCCH slot can be monitored by any of the UEs 111-116 of FIG. 1, such as the UE 116. This example is for illustration only and other embodiments can be used without departing from the scope of the present disclosure.

FIG. 14 illustrates an example periodicity 1400 for PDCCH slots according to embodiments of the present disclosure. For example, periodicity 1400 for PDCCH slots can be monitored by any the UE 116 of FIG. 3. This example is for illustration only and other embodiments can be used without departing from the scope of the present disclosure.

In one example, multiple instances/MOs of Channel A are associated with multiple PDCCH MOs for search space sets. In one example, if the information payload of Channel A is too large to be provided in one instance/MO of Channel A, such as when a desired code rate for the information that is to be provided by Channel A cannot be achieved using time/frequency resources configured for Channel A, the payload can be partitioned across multiple instances/MOs of Channel A as illustrated in FIG. 13 and FIG. 14. In one example, Channel A is repeated multiple times with a same payload, for example for improved coverage. In one example, Channel A is repeated multiple times with a same payload using different spatial domain transmission filters (e.g., different TCI states or different beam indications). In another example, channel A is repeated multiple times with a same payload using a same spatial domain transmission filter (e.g., a same TCI state or a same beam indication), such as to allow for beam sweeping at the UE to refine a UE DL Rx beam.

In one example, an instance/MO of Channel A and associated PDCCH MOs are in non-overlapping time periods for example, as illustrated in example 1 of FIG. 8(A). In one example, the time gap between an instance/MO of Channel A and a first/earliest of the associated PDCCH MOs is T. In one example, T>Tₘᵢₙ. In one example, T≥Tₘᵢₙ. In one example, Tₘᵢₙ depends on a UE capability, such as for processing and applying for PDCCH MOs the information provided by Channel A. In one example, T is from start of an instance/MO of Channel A to a start of a first/earliest of the associated PDCCH MOs. In one example, T is from end of an instance/MO of Channel A to a start of a first/earliest of the associated PDCCH MOs. In one example, T is from start of an instance/MO of Channel A to end of a first/earliest of the associated PDCCH MOs. In one example, T is from end of an instance/MO of Channel A to end of a first/earliest of the associated PDCCH MOs. In one example, an instance/MO of Channel A and associated PDCCH MOs are in different slots or time units.

In one example, an instance/MO of Channel A and associated PDCCH MOs are in overlapping time periods, for example as illustrated in example 2 of FIG. 8(B). In one example, an instance/MO of Channel A and an associated PDCCH MO are frequency division multiplexed (FDMed).

In one example, an instance/MO of Channel A occupies M CCEs. In one example, M=1. In one example, M>1. In one example, M≥1. In one example, M is configured by higher layers. In one example, M can be selected from the set {2,4,8,16}. In one example, M can have one of multiple values and the UE receives Channel A according to each of the multiple values.

FIGS. 15A, 15B, and 15C illustrate example CCEs 1510, 1520, and 1530, respectively, according to embodiments of the present disclosure. For example, CCEs 1510, 1520, and 1530, respectively, can be received by any of the UEs 111-116 of FIG. 1. This example is for illustration only and other embodiments can be used without departing from the scope of the present disclosure.

In one example, for a CORESET with a number of N CCEs, the M CCEs of an instance/MO of Channel A are the first M CCEs of the N CCEs of the CORESET, e.g., 0, 1, . . . , M−1. This is illustrated in FIG. 15(A). Note that while the CCEs are shown consecutive, this is for the logical CCE index. The logical CCE index may be interleaved or non-interleaved when mapped to the physical CCE index. In another example, the CCEs can be indicated to a UE explicitly through higher layer signaling or implicitly through an indication of a candidate for Channel A.

In one example, for a CORESET with a number of N CCEs, the M CCEs of an instance/MO of Channel A are the last M CCEs of the N CCEs of the CORESET or monitoring occasion, e.g., N-M, N-M−1, . . . , N−1. This is illustrated in FIG. 15(B). Note that while, the CCEs are shown consecutive, this is for the logical CCE index. The logical CCE index may be interleaved or non-interleaved when mapped to the physical CCE index.

For example, the first M CCEs or the last M CCEs may be defined in a certain order, such as frequency first, time second or alternatively time first, frequency second.

In one example, for a CORESET with a number of N CCEs, the M CCEs of an instance/MO of Channel A are distributed across the N CCEs of the CORESET. In one example, the ith CCE of the M CCEs of an instance/MO of Channel A, where i=0, 1, . . . , M−1, can be CCE with index

$$⌊ i \frac{N}{M} ⌋ ,$$

or with index

$$⌊ i \frac{N}{M} ⌋ .$$

In one example, the ith CCE of the M CCEs of an instance/MO of Channel A, where i=0, 1, . . . , M−1, can be CCE with index

$$⌊ i \frac{N}{M} ⌋ ,$$

or with index

$$i ⌊ \frac{N}{M} ⌋ .$$

In one example, the ith CCE of the M CCEs of an instance/MO of Channel A, where i=0, 1, . . . , M−1, can be CCE with index i·R. In one example, the ith CCE of the M CCEs of an instance/MO of Channel A, where i=0, 1, . . . , M−1, can be CCE with index i·R+O. In one example, R is configured. In one example, (M−1)R≤N−1. In one example, MR≤N. In one example,

$$R = ⌊ \frac{N}{M} ⌋ .$$

In one example,

$$R = ⌊ \frac{N - 1}{M - 1} ⌋ .$$

In one example, O is configured. In one example, O=0, 1, . . . , R−1. In one example, the set of CCE indexes used by Channel A is configured by higher layers, e.g., RRC.

FIG. 15(C) illustrates an example of a CORESET with N=12 CCEs and M=4 CCEs used for an instance/MO of Channel A distributed throughout the N=12 CCEs of the CORESET. Note that while the CCEs are shown consecutive, this is for the logical CCE index. The logical CCE index may be interleaved or non-interleaved when mapped to the physical CCE index.

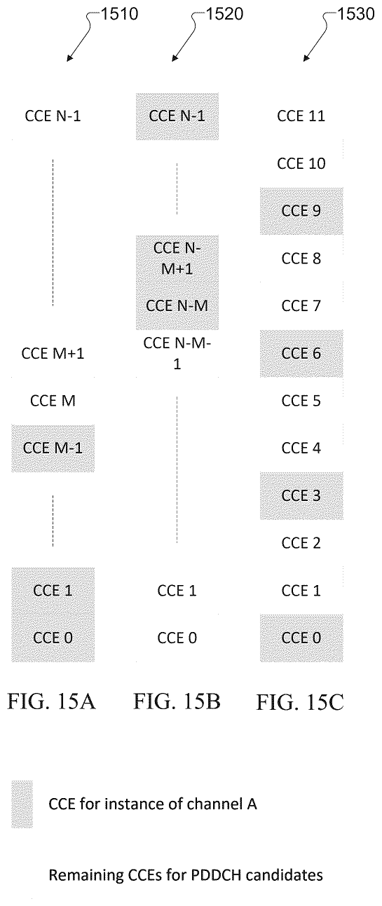

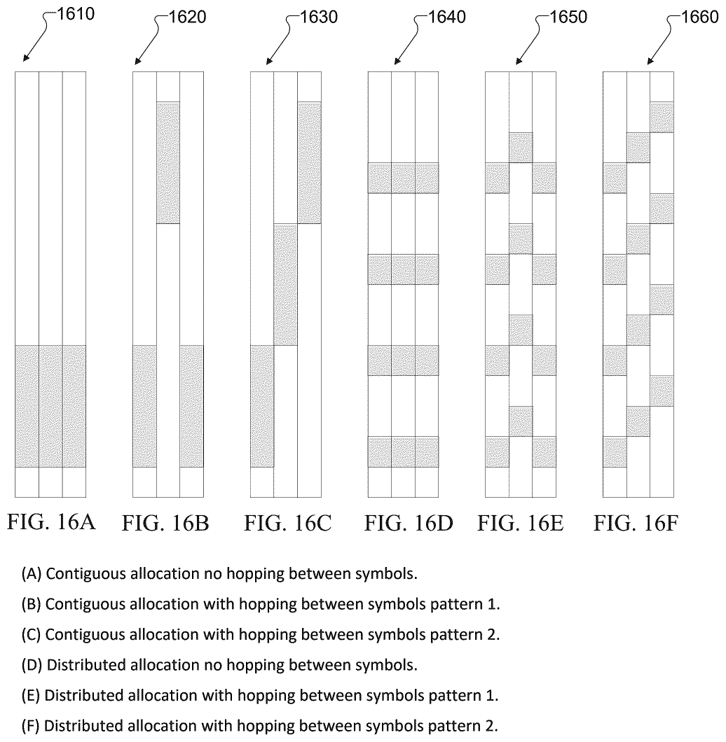

FIGS. 16A, 16B, 16C, 16D, 16E, and 16F illustrate example frequency domain allocations 1610, 1620, 1630, 1640, 1650, and 1660, respectively, according to embodiments of the present disclosure. For example, frequency domain allocations 1610, 1620, 1630, 1640, 1650, and 1660, respectively, can be received by any of the UEs 111-116 of FIG. 1. This example is for illustration only and other embodiments can be used without departing from the scope of the present disclosure.

In one example, the physical channel for Channel A is a new downlink channel different from PDCCH or PDSCH (e.g., referred to as physical downlink information channel or ‘PDICH’) or is a PDCCH. In one example, a UE is provided a configuration for Channel A, wherein the configuration for Channel A can be for resources that are separate from the resources of the associated search space sets and CORESETs. In one example, one or more of the following parameters (or a subset of them) can be provided for the configuration of Channel A (using one or multiple RRC IEs):
Time domain resources, such as symbols or in general time units, used for Channel A. For example, a starting symbol or time unit and/or an ending symbol or time unit and/or a duration in a number of consecutive symbols or time units and/or symbol indexes. A time offset T (in symbols or time units) before an associated PDCCH MO. The time T can be as mentioned herein. A periodicity in symbols or slots or time units. In one example, time domain resource configuration can be absent, e.g., the time resources of Channel A are the time resources of an associated/indicated CORESET for Channel A or PDCCH MO or a subset of them. For example, when Channel A is linked to multiple search space sets, the UE monitors/receives Channel A in symbols/slots/occasions of CORESETs associated with linked search space sets or in indicated CORESETs from the CORESETs.
Frequency domain resources. In one example, the allocation is contiguous in the frequency domain as illustrated in FIG. 16(A). In one example the allocation is distributed in the frequency domain as illustrated in FIG. 16(D). In one example, frequency domain resources can be provided by a starting RB or frequency-unit and/or an ending RB or frequency-unit and/or a length in PRBs or frequency-units and/or RB indexes or VRB (virtual resource blocks) indexes. In one example, frequency domain resources can be provided by a bitmap of RBs or groups of RBs or frequency-units or groups of frequency-units. In one example, a hopping pattern or interleaving pattern can be configured between symbols as illustrated in FIGS. 16 (B), (C), (E) and (F). For example, when time/frequency resources for Channel A are in a CORESET, the time/frequency resources can be CCEs and the interleaving pattern can be same as for CCEs of PDCCH candidates. In one example, a frequency offset F (in REs or RBs or other frequency units) relative to the linked CORESET, e.g., resources for Channel A start from the first/smallest RB or last/largest RB of the linked CORESET and by applying the frequency offset F, if any, or resources for Channel A end at the last/largest RB (or first/smallest RB) of the linked CORESET after applying the frequency offset F, if any.
Spatial domain resource. Information of a TCI state or QCL information for reception of Channel A, at least when Channel A is not in same slots/symbols and RBs as a CORESET. In one example, the information can be absent, e.g., Channel A follows a same TCI state as a TCI state for an associated CORESET or search space set linked to a CORESET. In one example Channel A follows a unified or indicated or main TCI state. In one example, Channel A is provided a flag for whether or not to follow the unified or indicated or main TCI state. In one example, a UE is provided a flag that indicates a TCI state to follow for receptions of Channel A, for example, in case of two indicated TCI states to the UE, the flag can be first or second or both or none. In one example, Channel A is configured a TCI state. In one example, Channel A can be configured multiple TCI states and the UE receives Channel A according to the multiple TCI states.
ID of linked CORESET(s): to indicate a corresponding CORESET for the resources of Channel A or for the resources of the PDCCH MOs. That indication can be absent, e.g., when the linked search space sets are configured or otherwise indicated, and the linked CORESET can be identified from the linked search space sets, or when the present configuration for Channel A is provided inside the configuration for a CORESET, that CORESET is the linked CORESET associated with Channel A.
ID of linked search space sets: to indicate the associated search space sets with applicable information from Channel A. That indication can be absent, e.g., when Channel A is linked with search space sets associated with the indicated linked CORESET(s), or when Channel A instances/MOs are present in PDCCH MOs for a search space set, then the UE identifies the linked search space sets to be those search space sets that have PDCCH MOs in a certain occasion of Channel A or with a time offset to Channel A. In one example, the linkage of a search space set to Channel A is provided in the search space set configuration.
Scrambling code for DMRS of Channel A.
Coding and modulation for Channel A and/or Payload size of the information provided by Channel A. For example, an MCS for Channel A can be configured. For example, modulation configuration can be absent for Channel A, such as when Channel A is modulated using QPSK. For example, coding rate can be absent, such as when a smallest coding rate configured to the UE, e.g., for PDSCH, is used for Channel A, or when the UE can implicitly determine the coding rate, e.g., using the Channel A payload size and the number of time/frequency resources (symbols and RBs) such as a number of CCEs in a CORESET that are allocated to Channel A.
Indication to a UE to determine the part of the payload intended to the UE. In one example, the UE can be indicated an index for bits in the payload or an RNTI that the UE can respectively use to determine the part of the payload for the UE or to determine whether part or all of the payload is intended for the UE, as described later in this disclosure. In one example, this can be a field or a number of bits (e.g., block of bits) in the payload intended to the UE as described later in this disclosure.

In one example, instances/MOs for Channel A are based on the UE DRX configuration and/or cell DTX/DRX configuration and/or PDCCH skipping. For example, when the UE (e.g., the UE 116) is configured or indicated to not monitor PDCCH according to one or more search space sets for a number of slots or for a number of PDCCH MOs, the UE may not monitor or receive Channel A in the number of slots or for the associated PDCCH MOs.

With reference to FIG. 16, different examples of frequency domain allocation are shown for Channel A. In FIG. 16(A), the resources for Channel A are contiguous (e.g., localized) in the frequency domain, with no hopping/interleaving between symbols. In FIG. 16(B), the resources for Channel A are contiguous (e.g., localized) in the frequency domain, with hopping/interleaving between symbols, in the example of FIG. 16(B), there are two hopping/interleaving patterns, a first hopping/interleaving pattern used in the first and third symbols (e.g., odd symbols) and a second hopping/interleaving pattern used in the second symbol (e.g., even symbols). In FIG. 16(C), the resources for Channel A are contiguous (e.g., localized) in the frequency domain, with hopping/interleaving between symbols, in the example of FIG. 16(C), there are three hopping/interleaving patterns, a first hopping/interleaving pattern used in the first symbol, a second hopping/interleaving pattern used in the second symbol, and a third hopping/interleaving pattern used in the third symbol. In FIG. 16(D), the resources for Channel A are distributed in the frequency domain, with no hopping/interleaving between symbols. In FIG. 16(E), the resources for Channel A are distributed in the frequency domain, with hopping/interleaving between symbols, in the example of FIG. 16(E), there are two hopping/interleaving patterns, a first hopping/interleaving pattern used in the first and third symbols (e.g., odd symbols) and a second hopping/interleaving pattern used in the second symbol (e.g., even symbols). In FIG. 16(F), the resources for Channel A are distributed in the frequency domain, with hopping/interleaving between symbols, in the example of FIG. 16(F), there are three hopping/interleaving patterns, a first hopping/interleaving pattern used in the first symbol, a second hopping/interleaving pattern used in the second symbol, and a third hopping/interleaving pattern used in the third symbol.

In one example, the physical channel for Channel A is a PDCCH or a channel based on PDCCH. In one example, a UE is provide a configuration for a PDCCH that provides Channel A, wherein the configuration for the PDCCH can be for resources shared with resources of an associated search space set in a linked CORESET. In one example, one or more of the following parameters can be provided for the configuration:
The number of CCEs used for Channel A (e.g., aggregation level of Channel A)
The starting CCE of Channel A
The ending CCE of Channel A
The number of one or more candidates of Channel A for one or more CCE aggregation levels
Indication whether the CCEs of Channel A are contiguous (e.g., localized) or distributed, if not determined by the configuration of an associated CORESET.
For distributed CCEs, the distance (in number of CCEs, e.g., R) between CCEs and/or offset, e.g., O.
Spatial domain resource. In one example Channel A follows a same TCI state as an associated CORESET or search space set, for example when Channel A is received in symbols/RBs of the CORESET. In one example Channel A follows the unified or indicated or main TCI state. In one example, a UE is provided a flag for Channel A wherein the flag indicates whether or not to the UE follows the unified or indicated or main TCI state for the Channel A reception. In one example, the UE is provided a flag for Channel A, wherein the flag indicates to the UE a TCI state to follow, for example in case of two indicated TCI states, the flag can indicate first or second or both or none. In one example, a UE is indicated a TCI state for Channel A, for example when the UE receives Channel A in different time or frequency resources than the one for a CORESET.
ID of linked CORESET(s), as mentioned herein.
ID of linked search space sets, as mentioned herein.
MCS or Payload size.
Indication to a UE to determine the part of the payload intended to the UE. In one example, this indication can be a configuration of an index for the UE to determine bits in the payload of Channel A that are intended for the UE, or an RNTI index for the UE to determine whether Channel A is intended for the UE as described later in this disclosure. In one example, the indication can be a field or a number of bits (e.g., block of bits) in the payload intended to this UE as described later in this disclosure.

For example, certain parameters may be absent, such as number or index of CCEs for Channel A, for example, when the first or last CCEs in the CORESET is used for Channel A, or when Channel A is a PDCCH and the UE is indicated PDCCH candidates for Channel A, as previously described.

In one example, the physical channel for Channel A is PDSCH or a channel based on PDSCH. In one example, a UE is provided a configuration for PDSCH, the configuration for PDSCH can be provided by higher layers. In one example, one or more of the following parameters can be provided for the configuration:
Time domain resources that can include symbols, slot, or time unit(s) used for Channel A. For example, an indication for time domain resources can include a starting symbol or time-unit and/or an ending symbol or time-unit and/or a duration in symbols, slots, or time-units. A time T (in symbols, slots, or time-units) before an associated PDCCH MO. The time T can be as mentioned herein. A periodicity in symbols or slots or time-units. In one example, the time resources of Channel A are the time resources of the PDCCH MO or a subset of them.
Frequency domain resources. In one example, the allocation is contiguous in the frequency domain as illustrated in FIG. 16(A). In one example the allocation is distributed in the frequency domain as illustrated in FIG. 16(D). In one example, frequency domain resources can be provided by a starting PRB or frequency-unit and/or an ending PRB or frequency-unit and/or a length in PRBs or frequency-units. In one example, frequency domain resources can be provided by a bitmap of PRBs or groups of PRBs or frequency-units or groups of frequency-units. In one example, a hopping/interleaving pattern can be configured between symbols as illustrated in FIGS. 16 (B), (C), (E) and (F).
Spatial domain resources. In one example Channel A follows a same TCI state as the associated CORESET or search space set linked to a CORESET used to provide DCI that schedules the Channel A reception or linked to Channel A. In one example Channel A follows a TCI state indicated by a DCI that schedules the Channel A reception. In one example Channel A follows a TCI state with quasi co-location properties of an SS/PBCH block the UE uses to obtain SIB1 for a serving cell. In one example Channel A follows the unified or indicated or main TCI state. In one example, a UE is provided with a flag for Channel A reception, wherein the flag indicates to the UE whether or not to follow the unified or indicated or main TCI state. In one example, a UE is provided a flag for Channel A reception, wherein the flag indicates to the UE a TCI state to follow. For example, in case of two indicated TCI states, the flag can indicate first or second or both or none. In one example, a configuration for Channel A reception includes a TCI state.
Scrambling code for DMRS.
ID of linked CORESET(s), as mentioned herein (e.g., CORESET of PDCCH MOs linked to channel A).
ID of linked search space set(s), as mentioned herein (e.g., search space set of PDCCH MOs linked to channel A).
MCS and/or Payload size.
Indication to a UE to determine the part of the payload intended to the UE. In one example, this indication can be a configuration of an index for the UE to determine bits in the payload of Channel A that are intended for the UE, or an RNTI index for the UE to determine whether Channel A is intended for the UE as described later in this disclosure. In one example, the indication can be a field or a number of bits (e.g., block of bits) in the payload intended to this UE as described later in this disclosure.

For example, the PDSCH that provides Channel A can be an RRC-configured/activated semi-persistent scheduling (SPS) PDSCH. In one example, the SPS PDSCH for Channel A is activated by default, e.g., after configuration. In one example, the SPS PDSCH for Channel A is activated by RRC/SIB configuration.

The examples of FIG. 16 apply to Channel A using PDSCH for contiguous (e.g., localized) or distributed allocation, with no frequency hopping/interleaving or with frequency hopping/interleaving.

In one example, Channel A is a PDSCH and is scheduled to UE by a DCI Format or by MAC CE signaling.

In one example, the container providing the payload of Channel A is a downlink control information (DCI) format such as DCI format X or a new downlink information (DI) that can be processed using a different coding scheme or a different MCS than other DCI formats. For example, channel coding for DI can be based on Reed-Muller coding or on LDPC coding or variants thereof, or Polar coding or variants thereof used for DCI formats. In one example, DCI format X or DI is provided by a PDCCH. In one example DCI format X or DI is provided by a PDSCH. In one example, DCI format X or DI is provided by a new downlink channel, e.g., referred to as physical downlink information channel ‘PDICH’.

In one example, the container providing the payload of Channel A is a Medium Access Control Channel Element (MAC CE). In one example, the MAC CE is provided by a PDCCH. In one example MAC CE is provided by a PDSCH.

In one example, the container providing the payload of Channel A is a Radio Resource Control (RRC) message. In one example, the RRC message is provided by a PDCCH. In one example the RRC message is provided by a PDSCH.

In one example, CRC is applied to the payload of Channel A, such as DCI format X or DI. In one example, the CRC is not scrambled. In one example, CRC is scrambled by a predetermined or configured value. In one example, CRC is scrambled by a new RNTI configured for DCI format X or for DI, such as DI-RNTI that is commonly configured to UEs in a cell or configured to a group of UEs in a cell that share a same Channel A. In one example, a different group of UEs in the cell can be configured a different DI-RNTI for reception of DCI format X or DI in different Channel A. In one example, a different group of UEs in the cell can be configured a different DI-RNTI for reception of DCI format X or DI in Channel A, for example if Channel A is scrambled with a first DI-RNTI, it is to a first UE or a first a group of UEs, if Channel A is scrambled with a second DI-RNTI, it is to a second UE or a second group of UEs.

In one example resources are configured for Channel A, and Channel A can be linked to a search space set(s) and/or CORESET(s) of PDCCH MOs as described in this disclosure. In one example, channel A can be a purpose-designed channel. In one example, Channel A can be PDCCH. In one example, Channel A can be PDSCH. In one example, resources can include time (e.g., symbol(s) within slot/sub-frame, slot/sub-frame offset, periodicity, etc.) and frequency resources (e.g., starting/ending/length of PRBs or sub-carriers or sub-channels). In one example, a value can be configured to scramble the CRC of Channel A.

In one example resources are configured for MOs of Channel A, and MOs of Channel A can be linked to a search space set(s) and/or CORESET(s) of PDCCH MOs as described in this disclosure. In one example, resources can include time (e.g., symbol(s) within slot/sub-frame, slot/sub-frame offset, periodicity, etc.) and frequency resources (e.g., starting/ending/length of PRBs or sub-carriers or sub-channels). In one example, a value can be configured to scramble the CRC of Channel A.

In one example, the content of Channel A can indicate the linked MO(s) or search space set(s) or CORESET(s) as described in this disclosure.

In one example, when the UE does not detect Channel A, the UE receives the PDCCH without any assistance information from Channel A, for example, by receiving and decoding DCI for PDCCH candidates associated with search space sets at respective PDCCH MOs, until the UE receives/correctly decodes information provided by Channel A at the applicable time of that information. In one example, before UE-dedicated RRC connection or after UE-dedicated RRC connection and until reception of the configuration information for Channel A, the UE receives PDCCH without any assistance information from Channel A, for example, by receiving and decoding DCI for PDCCH candidates associated with search space sets at respective PDCCH MOs.

For example, a Channel A can be configured to apply only for USS sets, or only for CSS sets configured by UE-specific higher layer signaling, such as Type-3 CSS sets in 5G/NR, or only for CSS sets configured by cell-specific higher layer signaling, such as Type-0/0A/1/1A/2/2A CSS sets in 5G/NR, or can be configured to apply for a combination of the search space sets described herein, such as for USS sets and for CSS sets configured by UE-specific higher layer signaling (and not apply, by default, to CSS sets configured by cell-specific higher layer signaling).

In one example, a Channel A is configured to apply to USS sets, a PDCCH candidate indicated by Channel A can be to one UE, e.g., based on UE-specific index and/or a UE-specific block of bits.

In one example, a Channel A is configured to apply to CSS sets, a PDCCH candidate indicated by Channel A can be to a group of UEs, e.g., based on group-UE-specific index and/or a group-UE-specific block of bits. In one example, a group of UEs is a subset of the UEs in a cell or a group of cells. In one example, a group UE is UEs in a cell. In one example, a group UE is UEs in a group of cells.

In one example, a Channel A is configured to apply to CSS sets other than Type-3 CSS sets, a PDCCH candidate indicated by Channel A can be to a group of UEs, e.g., based on group-UE-specific index and/or a group-UE-specific block of bits. In one example, a group of UEs is a subset of the UEs in a cell or a group of cells. In one example, a group UE is UEs in a cell. In one example, a group UE is UEs in a group of cells.

In one example, a Channel A is configured to apply to Type-3 CSS sets, a PDCCH candidate indicated by Channel A can be to one UE, e.g., based on UE-specific index and/or a UE-specific block of bits. In one example, a Channel A is configured to apply to Type-3 CSS sets, a PDCCH candidate indicated by Channel A can be to one or more UEs, e.g., based on UE-specific index and/or a UE-specific block of bits and/or UE group common index (or cell common index) and/or UE group common (or cell common) block of bits.

In one example, Channel A is linked to a search space set by including a Channel A configuration or Channel A index (e.g., Channel A configuration index) in the search space set configuration.

In one example, Channel A is linked to a search space set by including a Channel A configuration or Channel A index (e.g., Channel A configuration index) in a CORESET configuration, wherein the CORESET is associated with (or linked to) the search space set.

In one example, Channel A is linked to a search space set by including the search space set ID (or index) in the Channel A configuration.

In one example, Channel A is linked to a search space set by including a CORESET ID (or index) in the Channel A configuration, wherein the CORESET is associated with (or linked to) the search space set.

In one example, Channel A is linked to a CORESET by including a Channel A configuration or Channel A index (e.g., Channel A configuration index) in the CORESET configuration.

In one example, Channel A is linked to a CORESET by including a Channel A configuration or Channel A index (e.g., Channel A configuration index) in a search space set configuration, wherein the search space set is associated with (or linked to) the CORESET.

In one example, Channel A is linked to a CORESET by including the CORESET ID (or index) in the Channel A configuration.

In one example, Channel A is linked to a CORESET by including a search space set ID (or index) in the Channel A configuration, wherein the search space set is associated with (or linked to) the CORESET.

Channel A provides information to assist one or more UEs to decode PDCCH candidates in PDCCH MOs associated with channel A. The following information can be provided by channel A:
Time/Frequency resources used of PDCCH candidates this can include CCEs (start/end/length (e.g., AL)) of PDCCH candidates and/or PDCCH candidate index.
Payload of PDCCH candidates, this can include DCI Format and/or payload size
PDCCH MOs or SS sets associated with channel A.

For a UE to identify the PDCCH candidates intended for that UE:
Channel A has multiple entries; an entry includes a tag (or index) to identify intended target of PDCCH candidate. Intended target can be UE (e.g., UE index) and/or RNTI
Channel A includes blocks of bits (determined by start/end/length), wherein each block of bit is associated with an intended target (UE and/or RNTI).

In one example, Channel A includes multiple entries, wherein an entry can be associated with a PDCCH candidate. In one example, an entry provides information for the associated PDCCH candidate. In one example, an entry includes an index or ID and based on the index or ID a UE can determine whether or not the PDCCH is intended to UE. In one example, a UE receives and decodes the PDCCH candidates intended to the UE. In one example, a UE can parse Channel A for index(es) intended to the UE. In one example, a UE is configured or indicated one or more indexes associated with PDCCH candidates of search space sets configured to the UE. In one example, if the UE determines a configured or indicated index in Channel A, the UE receives and decodes one or more corresponding PDCCH candidates for one or more respective search space sets in one or more CORESETs linked to the search spaces sets on PDCCH MOs associated with Channel A. In one example, an index can be associated with one or more USS sets. In one example, an index can be associated with one or more CSS set configured to the UE by UE-dedicated higher layer signaling. In one example, an index can be associated with CSS sets configured to the UE by cell-specific higher layer signaling. In one example, an index can be reserved for other purposes. In one example, a reserved index can be used to indicate unallocated CCEs or CORESETs. In one example, the index can indicate a block of bits of the information provided by Channel A. In one example, the index is for an RNTI. In one example, the index can be a CORESET index, or a CSS set index, or a USS set index. In one example, the index can correspond to one or more search space sets and to one or more PDCCH candidates for each of the search space sets, wherein the one or more search space sets can be identified by a corresponding index, such as for a group of search space sets that includes the search space sets, and the one or more PDCCH candidates can be identified by a corresponding index, such as for a group of PDCCH candidates for associated CCE aggregation levels that includes the PDCCH candidates.

In one example, the information payload of Channel A includes a list of entries, e.g., N entries or N blocks. In one example, N is configured or indicated to a UE, as part of the Channel A configuration. In one example, N is defined in the system specifications. In another example, the UE can be configured a positionInDCI parameter indicating a starting bits for the block of bits within the payload of Channel A (e.g., within DCI format X or within the DI, as previously described). In another example, a number of bits for each entry or block is defined in the system specifications or is configured to the UE by higher layers, such as by a numberOfBits parameter. In one example, different blocks have the same number of bits. In one example, different blocks can have different number of bits. The (re-)configuration or indication can be by UE-specific RRC, and/or by a system information block (SIB), and/or a MAC CE, and/or L1 control (e.g., DCI Format) signaling. In one example the bits of an entry indicate one or more of: (1) an index for a group of search space sets including the case of an index for a single search space set, (2) an index for corresponding PDCCH candidates of the search space sets and/or a starting CCE; and (3) an aggregation level as illustrated in Table 3. Groups of search space sets and corresponding indexes can be configured to the UE by UE-specific RRC signaling. Groups of PDCCH candidates and corresponding indexes can be configured to the UE by UE-specific RRC signaling. The groups of PDCCH candidates can also include CCE aggregation levels, for example when the PDCCH candidates are indexed across aggregation levels, or groups of one or more CCE aggregation levels and corresponding indexes can be separately configured for example when PDCCH candidates are indexed per CCE aggregation level. In the latter case, the bits of the entry can additionally indicate an index for a group of one or more CCE aggregation levels.

In one example, in Table 3, a starting CCE index and a CCE aggregation level are provided for each entry, wherein the starting CCE index and the CCE aggregation level determine the resource of the corresponding PDCCH candidate. In one example, the granularity of the starting CCE can be the CCE aggregation level. In one example, in Table 3a, a PDCCH candidate index and a CCE aggregation level are provided for each entry, wherein the PDCCH candidate index and the CCE aggregation level determine the resource of the corresponding PDCCH candidate. In one example, the starting CCE index for a PDCCH candidate index and a CCE aggregation level is given by: starting CCE index=PDCCH candidate index*CCE aggregation level. In one example, the starting CCE index is determined based on a hashing function, e.g., using the PDCCH candidate index and the CCE aggregation level as mentioned herein.

TABLE 3

| | | | |
|---|---|---|---|
| Entry or block (0) | Index (0) | Starting CCE(0) | CCE Aggregation |
| | | | level (0) |
| Entry or block (1) | Index (1) | Starting CCE(1) | CCE Aggregation |
| | | | level (1) |
| . . . | . . . | . . . | . . . |
| Entry or block (i) | Index (i) | Starting CCE(i) | CCE Aggregation |
| | | | level (i) |
| . . . | . . . | . . . | . . . |
| Entry or block | index (N-1) | Starting CCE | CCE Aggregation |
| (N-1) | | (N-1) | level (N-1) |

TABLE 3A

| | | | |
|---|---|---|---|
| Entry or block (0) | Index (0) | PDCCH | CCE Aggregation |
| | | Candidate(0) | level (0) |
| Entry or block (1) | Index (1) | PDCCH | CCE Aggregation |
| | | Candidate (1) | level (1) |
| . . . | . . . | . . . | . . . |
| Entry or block (i) | Index (i) | PDCCH | CCE Aggregation |
| | | Candidate (i) | level (i) |
| . . . | . . . | . . . | . . . |
| Entry or block | index (N-1) | PDCCH | CCE Aggregation |
| (N-1) | | Candidate(N-1) | level (N-1) |

In one example, the UE (e.g., the UE 116) receives Channel A that is associated with a number of MOs corresponding to a number search space sets and decodes the information provided by Channel A. In one example, the information is a DCI format with CRC scrambled by an RNTI configured to the UE by higher layers. In another example, the information is a DCI Format with CRC not scrambled with an RNTI. In one example, the UE searches the N entries, for an index corresponding to the one or more indices configured to the UE as mentioned herein. For an index(i) corresponding to the one or more indices configured to the UE that the UE finds, the UE determines the starting CCE(i) and the aggregation level(i) of an entry(i) corresponding to index(i) and the UE receives and decodes the PDCCH candidate accordingly. In one example, the starting CCE index can have a granularity of 1 CCE. In one example, the starting CCE index can have a granularity provided, by CCE aggregation level. In one example PDCCH candidate (e.g., as illustrated in Table 3a and previously described) can be used to determine a starting CCE as mentioned herein.

In one example, from the N entries of the information provided by Channel A, the UE determines a number of blocks of bits based on respective higher layer parameters configured to the UE for the starting position and for the number of bits, if not common to blocks of bits and separately defined or configured, of each block of bits. Blocks of bits for the UE can be consecutive, only the starting position for the first block is configured and the starting position of a block other than the first block is determined by the starting position of the first block and by the total number of bits of blocks that are located prior to the block. The number of blocks of bits can be configured to the UE by higher layers and the information for each block of bits can be also configured by higher layers or be defined in the specifications of the system operation. For example, a first block of bits can indicate an index for a group of search space sets, including directly indicating a search space set index in case groups of search space sets are not defined, and second block of bits can indicate a group of PDCCH candidates for the group of search space sets. The groups of search space sets and their indexes, as well as the groups of PDCCH candidates and their indexes, can be separately configured to the UE by higher layers for example using UE-specific and/or cell-specific RRC signaling. If the PDCCH candidates are not indexed across CCE aggregation levels and are instead indexed per CCE aggregation level, a third block of bits can indicate a group of a CCE aggregation levels associated with the group of PDCCH candidates. The indication by the blocks of bits remains valid until a next instance/MO for Channel A with the addition of an application time after the next instance/MO for Channel A as previously described.

In one example, Channel A is associated with K PDCCH MOs, e.g., MO₀, MO₁, . . . , MO_{K-1}. In one example, Starting CCE for a PDCCH candidate in monitoring occasion k, includes the starting CCE in a monitoring occasion k, and an index or ID for monitoring occasion k. In one example, if N_{CCE} is the number of CCEs in a monitoring occasion, or if N_{CCE} is maximum number of CCEs across any of the k monitoring occasions, Starting CCE for a PDCCH candidate in monitoring occasion k, can be given by kN_{CCE}+starting CCE in monitoring occasion k. In one example, if the number of CCEs in each of the K monitoring occasions is given by N_{CCE,0}, N_{NCCE,1}, . . . , N_{CCE,K-1}, Starting CCE for a PDCCH candidate in monitoring occasion k, can be given by

$${\sum }_{i = 0}^{k - 1} {N}_{CCE , i} + starting CCE in monitoring occasion k .$$

In on example, the parameters for an entry(i) provided by Channel A, apply to K PDCCH MOs (e.g., one entry in Channel A points to same candidate in each of the K PDCCH MOs). In one example, K can be determined by the number of PDCCH MOs between consecutive occurrences of Channel A, taking into account the Channel A processing latency.

In one example, when Channel A is associated with multiple PDCCH MOs, an entry or block can additionally include an index for one or more MOs for which the information provided by Channel A is applicable.

In one example, the payload of a channel includes a list of entries, e.g., N entries. In one example, N is configured or indicated to the UE. In one example, N is defined in the system specifications. The (re-)configuration or indication can be by UE-specific/cell-specific RRC, and/or SIB, and/or MAC CE, and/or L1 control (e.g., DCI Format) signaling. In one example each entry is applicable for search space sets, such as USS sets or CSS sets configured by UE-dedicated higher layer signaling and includes: (1) an index for a group of one or more PDCCH candidates, including an index for a PDCCH candidate in case a group of PDCCH candidates is not defined (for a group index Channel A can also indicate the number of PDCCH candidates for a given CCE AL, in one example, one entry can correspond to 0 candidates); and (2) a CCE aggregation level, as illustrated in Table 4. In variant example, each entry is applicable for search space sets associated with Channel A. In variant example, a search space set is indicated is indicated in channel A.

In one example each entry is applicable for search space sets, such as USS sets or CSS sets configured by UE-dedicated higher layer signaling and includes: (1) an index of a target of a PDCCH candidate (e.g., UE or RNTI); and (2) a CCE aggregation level, as illustrated in Table 4. In variant example, each entry is applicable for search space sets associated with Channel A. In variant example, a search space set is indicated is indicated in channel A.

In one example, the entries in table 4 are in ascending order of starting CCE, i.e., an earlier entry in Table 4 has a lower starting CCE than a later entry in Table 4. In one example, in Table 4, if entry(i) has a starting CCE as “Starting CCE(i)” and “aggregation level(i)”, the starting CCE for the next entry, i.e., entry(i+1), is “Starting CCE(i+1)”=“Starting CCE(i)”+“aggregation level(i)”. For example, starting CCE for the first block entry, i.e., for entry/block (0) can be CCE index 0.

TABLE 4

| | | |
|---|---|---|
| Entry (0) | Group Index | CCE aggregation level |
| | (0)/Index (0) | (0) |
| Entry (1) | Group Index | CCE aggregation level |
| | (1)/Index (1) | (1) |
| . . . | . . . | . . . |
| Entry (i) | Group Index (i)/ | CCE aggregation level |
| | Index (i) | (i) |
| . . . | . . . | . . . |
| Entry(N-1) | Group Index (N-1)/ | CCE aggregation level |
| | Index (N-1) | (N-1) |

In one example, the UE receives a Channel A associated with a number of PDCCH MOs corresponding to a number of search space sets. A number of blocks of bits associated with a UE also includes a block of bits identifying the UE, for example a 16-bit (or 8-bit) block providing the UE ID or an 8-bit block providing an ID for a group of UEs that include the UE. A position in the information payload of Channel A for the first bit of the block of bits providing the UE ID or the UE group ID for the UE can be indicated to the UE by higher layer signaling. When the UE finds the UE ID or the UE group ID, the UE processes remaining blocks of bits that provide information for PDCCH monitoring associated with one or more of a number of search space sets, a number of PDCCH candidates per CCE aggregation level, and a number of PDCCH MOs for which the Channel A is applicable for.

In one example, the UE searches the N entries, for an index corresponding to the one or more indices configured to the UE as mentioned herein. For an index(i) corresponding to the one or more indices configured to the UE that the UE finds, the UE determines the starting CCE(i) and the aggregation level(i) of an entry(i) corresponding to index(i) and the UE receives and decodes the PDCCH candidate accordingly. The starting CCE is determined by summing the pervious aggregation levels in the table as follows (for entry corresponding to i):

$$Starting CCE ( i ) = Starting CCE ( 0 ) + {\sum }_{j = 0}^{i - 1} Aggregation level ( j )$$

In one example, Starting CCE(0)=0, e.g., entry corresponding to 0, starts from CCE 0 of the CORESET or monitoring occasion.

In one example, Starting CCE(0) is configured and/or updated by RRC signaling and/or SIB signaling and/or MAC CE signaling and/or L1 control (e.g., DCI) signaling.

In one example, Starting CCE(0) is included as part of the payload of Channel A.

In one example, the UE searches the N entries, for a group index corresponding to the one or more indices configured to the UE as mentioned herein. For a group index(i) corresponding to the one or more indices configured to the UE that the UE finds, the UE determines the starting CCE(i) and the aggregation level(i) of an entry(i) corresponding to a group index(i) and the UE receives and decodes the PDCCH candidate(s) accordingly. The starting CCE is determined by summing the pervious aggregation levels in the table as follows (for entry corresponding to i):

$$Starting CCE of first candidate in grou p ( i ) = Starting CCE ( 0 ) + {\sum }_{j = 0}^{i - 1} Number of candidates ( j ) \times Aggregation level ( j )$$

$$Starting CCE of kth candidate in group ( i ) = Starting CCE of first candidate in group ( i ) + ( k - 1 ) \times Aggregation level ( i )$$

Where, k=1, 2, . . . Number of candidates (j).

In one example, the UE decodes Number of candidates (j), and determines PDCCH candidates for that UE based on an RNTI that scrambles the CRC of the PDCCH candidate.

In one example, additional information is provided in Channel A to determine which PDCCH candidates of the group are sent to which users of the group.

In one example, Starting CCE(0)=0, e.g., entry corresponding to 0, starts from CCE 0 of the CORESET or monitoring occasion.

In one example, Starting CCE(0) is configured and/or updated by RRC signaling and/or SIB signaling and/or MAC CE signaling and/or L1 control (e.g., DCI) signaling.

In one example, Starting CCE(0) is included as part of the payload of Channel A.

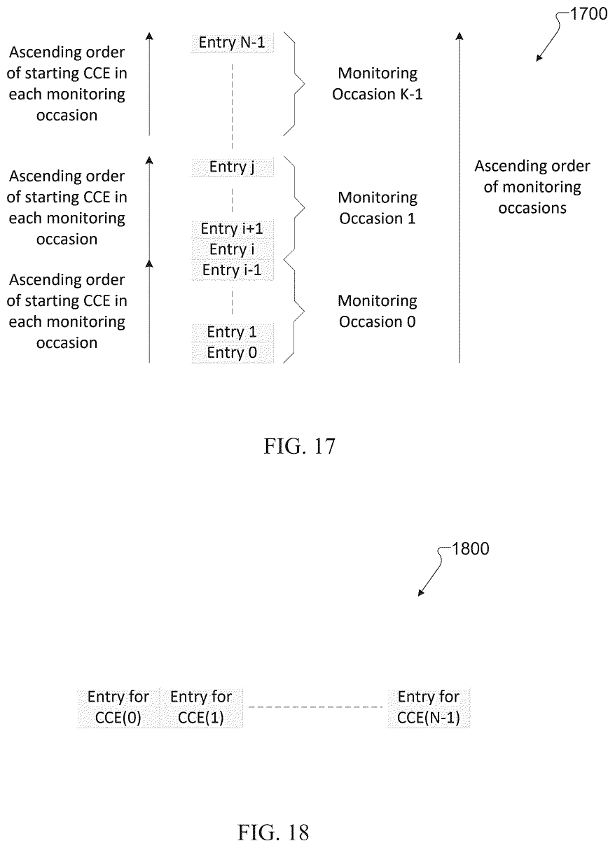

FIG. 17 illustrates an example of PDCCH MOs 1700 according to embodiments of the present disclosure. For example, PDCCH MOs 1700 can be monitored by any of the UEs 111-116 of FIG. 1, such as the UE 111. This example is for illustration only and other embodiments can be used without departing from the scope of the present disclosure.

In one example, when Channel A is associated with multiple PDCCH monitoring occasions, e.g., Channel A is associated with K PDCCH monitoring occasions, e.g., MO₀, MO₁, . . . , MO_{K-1}. In one example, the entries of Table 4, are arranged in order (e.g., ascending order) of starting CCE index for MO₀, then in order (e.g., ascending order) of starting CCE index for MO₁, and so on until in order (e.g., ascending order) of starting CCE index for MO_{K-1}, as illustrated in FIG. 17. In one example, the MOs, are arranged in ascending order of time.

In one example, an additional field is added to each entry of Table 4, wherein the additional field indicates a monitoring occasion index of the K PDCCH monitoring occasions associated with Channel A.

In one example, in Table 4, if entry(i) has a starting CCE as “Starting CCE(i)” and “aggregation level(i)”, and entry(i) and entry(i+1) are associated with a same monitoring occasion, the starting CCE for the next entry, i.e., entry(i+1), is “Starting CCE(i+1)”=“Starting CCE(i)”+“aggregation level(i)”.

In one example, if entry(i) is the first entry in the table for monitoring occasion k, “Starting CCE(i)”=0, e.g., first entry of a monitoring occasion starts from CCE 0 of that monitoring occasion.

In one example, if entry(i) is the first entry in the table for monitoring occasion k, “Starting CCE(i)”=“first CCE of monitoring occasion(k)”, wherein “first CCE of monitoring occasion(k)” is configured and/or updated by RRC signaling and/or SIB signaling and/or MAC CE signaling and/or L1 control (e.g., DCI) signaling. In one example, “first CCE of monitoring occasion(k)” can be different for each monitoring occasion(k), e.g., a different value is configured for each monitoring occasion. In one example, “first CCE of monitoring occasion(k)” is the same across monitoring occasions, e.g., one value configured for K monitoring occasions.

In one example, if entry(i) is the first entry in the table for monitoring occasion k, “Starting CCE(i)”=“first CCE of monitoring occasion(k)”, wherein “first CCE of monitoring occasion(k)” is included as part of the payload of Channel A. In one example, “first CCE of monitoring occasion(k)” can be different for each monitoring occasion(k), e.g., a different value is configured for each monitoring occasion. In one example, “first CCE of monitoring occasion(k)” is the same across monitoring occasions, e.g., one value configured for K monitoring occasions.

In one example,

$$Starting CCE ( i ) in monitoring Occasion k = first CCE of monitoring \\ \\ occasion ( k ) + {\sum }_{j = {j}_{0}}^{i - 1} Aggregation level ( j )$$

The summation in the last equation is over entries before entry i that are in monitoring occasion k. In one example j₀ is the first entry in monitoring occasion k.

In on example, the parameters for an entry(i) provided by Channel A, apply to K PDCCH MOs (e.g., one entry in Channel A points to same candidate in each of the K PDCCH MOs). In one example, K can be determined by the number of PDCCH MOs between consecutive occurrences of Channel A, taking into account the Channel A processing latency.

In one example, when Channel A is associated with multiple PDCCH MOs, e.g., Channel A is associated with K PDCCH monitoring occasions, e.g., MO₀, MO₁, . . . , MO_{K-1}. In one example, the number of CCEs in each of the K monitoring occasions is given by N_{CCE,0}, N_{NCCE,1}, . . . , N_{CCE,K-1}. In one example, the entries of Table 4, are arranged in order (e.g., ascending order) of starting CCE index for MO₀, then in order (e.g., ascending order) of starting CCE index for MO₁, and so on until in order (e.g., ascending order) of starting CCE index for MO_{K-1}, as illustrated in FIG. 17. In one example, the MOs, are arranged in ascending order of time.

In one example, in Table 4, if entry(i−1) has a starting CCE as “Starting CCE(i−1)” and “aggregation level(i−1)”, and entry(i−1) and entry(i) are associated with different monitoring occasion (e.g., monitoring occasions k−1 and k respectively), the starting CCE for the next entry, i.e., entry(i), is “Starting CCE(i)”=“first CCE of monitoring occasion(k)”. In one example, if “Starting CCE(i−1)”+“aggregation level(i−1)”≥N_{CCE,k-1}, entry(i) is associated with a different monitoring occasion (monitoring occasion k) than the monitoring occasion of entry(i−1) (monitoring occasion k−1).

In one example, “first CCE of monitoring occasion(k)”=0.

In one example, “first CCE of monitoring occasion(k)” is configured and/or updated by RRC signaling and/or SIB signaling and/or MAC CE signaling and/or L1 control (e.g., DCI) signaling. In one example, “first CCE of monitoring occasion(k)” can be different for each monitoring occasion(k), e.g., a different value is configured for each monitoring occasion. In one example, “first CCE of monitoring occasion(k)” is the same across monitoring occasions, e.g., one value configured for K monitoring occasions.

In one example, “first CCE of monitoring occasion(k)” is included as part of the payload of Channel A. In one example, “first CCE of monitoring occasion(k)” can be different for each monitoring occasion(k), e.g., a different value is configured for each monitoring occasion. In one example, “first CCE of monitoring occasion(k)” is the same across monitoring occasions, e.g., one value configured for K monitoring occasions.

In one example, if entry(i−1) has a starting CCE as “Starting CCE(i−1)” and “aggregation level(i−1)”, and entry(i−1) is associated with monitoring occasions k−1, and if “Starting CCE(i−1)”+“aggregation level(i−1)”≥N_{CCE,k-1}, entry(i) is associated with monitoring occasion k, and “Starting CCE(i)”=“Starting CCE(i−1)”+“aggregation level(i−1)”−N_{CCE,k-1}.

In one example, for entry(i)

$$Starting CCE ( i ) = Starting CCE ( 0 ) + {\sum }_{j = 0}^{i - 1} Aggregation level ( j )$$

If

$${\sum }_{j = 0}^{k - 1} {N}_{CCE , j} \leq S tarting CCE ( i ) < {\sum }_{j = 0}^{k 1} {N}_{CCE , j} ,$$

entry(i) is in monitoring occasion k.

In Table 3, Table 3a and in Table 4, the aggregation level can be provided by a code point corresponding to one of the configured aggregation levels of the search space. If a search space is configured with aggregation levels {1,2,4,8}, aggregation level 1 can corresponding code point 00, aggregation level 2 can corresponding code point 01, aggregation level 4 can corresponding code point 10, and aggregation level 8 can corresponding code point 11.

In one example in Table 3 or Table 3a or Table 4, an additional field is added to each entry of Table 4, wherein the additional field indicates a search space set index associated with Channel A.

In one example, for a search space set of a UE, there is a payload size/block of bits in the information provided by Channel A that indicate a subset of PDCCH candidates associated with the search space set for the UE to monitor. In one example, the payload size/block of bits can be part of the search space configuration.

In one example, for a search space set of UE there is a payload size for the PDCCH candidates associated with the search space set. In one example, the payload size can be part of the search space set configuration. The UE uses the configured payload size when decoding a PDCCH candidate in that search space set.

In one example, for a search space set of a UE, there are multiple payload sizes/blocks of bits in the information provided by Channel A that indicates a subset of PDCCH candidates associated with the search space set. In one example, the multiple payload sizes/blocks of bits can be part of the search space set configuration.

In one example, for a search space of a UE there are multiple payload sizes for the PDCCH candidates associated with the search space. In one example, the multiple payload sizes can be part of the search space configuration. The UE can decode multiple payload size hypothesis, based on the search space configuration, when decoding a PDCCH candidate in that search space, the UE checks the CRC of each decoded PDCCH candidate hypothesis to determine which hypothesis, if any, has a passing CRC.

In one example, a payload size/block of bits in the information provided by Channel A for a number of PDCCH candidates can be linked to an index provided by an entry. In one example, if a UE is configured with multiple indexes, each index can be configured a different payload size/block of bits for corresponding PDCCH candidates, for example as part of the search space set configuration or as a separate configuration. Based on the index(i) of an entry(i) the UE determines the payload size to decode the corresponding PDCCH candidates.

In one example, the payload size/block of bits associated with a set of PDCCH candidates can be linked to an index provided by an entry. In one example, if a UE is configured with multiple indexes, each index can be configured with one or more payload sizes/blocks of bits for corresponding one or more PDCCH candidates, for example as part of search space set configuration or as a separate configuration. Based on the index(i) of an entry(i) the UE determines the one or more payload size/blocks of bits for monitoring the corresponding PDCCH candidates.

The UE can decode multiple payload size hypotheses (if more than one), based on the configuration, when decoding a PDCCH candidate of entry(i), the UE checks the CRC of each decoded PDCCH candidate hypothesis to determine which hypothesis, if any, has a passing CRC.

In one example, the payload size can be linked to the DCI Format being received. In one example, for a search space set there is a DCI format for the PDCCH candidates transmitted in that search space set. In one example, for a search space there are multiple DCI Formats for the PDCCH candidates transmitted in that search space set. In one example, the DCI Format of a PDCCH candidate can be linked to the index provided by an entry. In one example, if a UE is configured with multiple indexes, each index can be configured a different DCI Format for the corresponding PDCCH candidate, for example this can be part of the search space set configuration or provided as a separate configuration. In one example, the DCI Format of a PDCCH candidate can be linked to the index provided by an entry. In one example, if a UE is configured with multiple indexes, each index can be configured with one or more DCI Formats for the corresponding PDCCH candidate, for example this can be part of the search space configuration or provided as a separate configuration.

In one example, a UE receiving a PDCCH candidate in a search corresponding to Entry(i) with Index(i) of the corresponding Channel A, determines one or more DCI Formats based on the search space and Index(i). The UE determines one or more payload sizes corresponding the one or more DCI Formats (in one example, multiple DCI Formats can be mapped to a same size). The UE decodes the PDCCH candidate based on the determined payload size (single decode, or decode with multiple hypothesis as mentioned herein).

In one example, the payload size and/or DCI format can be linked to the aggregation level. In one example, based on the aggregation level and/or index the UE can determine one or more payload size(s) or DCI Format(s) for the candidate PDCCH. The UE can decode multiple payload size hypothesis (if more than one), based on the configuration, when decoding a PDCCH candidate of entry(i), the UE checks the CRC of each decoded PDCCH candidate hypothesis to determine which hypothesis, if any, has a passing CRC.

In one example, when there are multiple decode hypothesis, information conveyed by Channel A can additionally provide a payload size and/or a DCI format as illustrated in Table 5, which corresponds to the example of Table 3 and Table 3a, or as illustrated in Table 6, which corresponds to the example of Table 4.

TABLE 5

| | | | | |
|---|---|---|---|---|
| Entry (0) | Index (0) | Starting CCE(0) | CCE | Payload size (0) or |
| | | or PDCCH | Aggregation | DCI Format (0) |
| | | candidate (0) | level (0) | |
| Entry (1) | Index (1) | Starting CCE(1) | CCE | Payload size (1) or |
| | | or PDCCH | Aggregation | DCI Format (1) |
| | | candidate (1) | level (1) | |
| . . . | . . . | . . . | . . . | . . . |
| Entry (i) | Index (i) | Starting CCE(i) | CCE | Payload size (i) or |
| | | or PDCCH | Aggregation | DCI Format (i) |
| | | candidate (i) | level (i) | |
| . . . | . . . | . . . | . . . | . . . |
| Entry(N-1) | index (N-1) | Starting CCE (N- | CCE | Payload size (N-1) |
| | | 1) or PDCCH | Aggregation | or DCI Format (N-1) |
| | | candidate (N-1) | level (N-1) | |

TABLE 6

| | | | |
|---|---|---|---|
| Entry (0) | Group | CCE Aggregation | Payload size (0) |
| | Index(0)/ | level (0) | or DCI Format (0) |
| | Index (0) | | |
| Entry (1) | Group | CCE Aggregation | Payload size (1) |
| | Index(1)/ | level (1) | or DCI Format (1) |
| | Index (1) | | |
| . . . | . . . | . . . | . . . |
| Entry (i) | Group | CCE Aggregation | Payload size (i) |
| | Index(i)/ | level (i) | or DCI Format (i) |
| | Index (i) | | |
| . . . | . . . | . . . | . . . |
| Entry(N-1) | Group Index(N- | CCE Aggregation | Payload size (N-1) |
| | 1)/Index (N-1) | level (N-1) | or DCI Format |
| | | | (N-1) |

In one example, according to the payload of Channel A provided in Table 5 or Table 6, the UE (e.g., the UE 116) receives the channel associated with a monitoring occasion of a search space, e.g., Channel A. The UE searches the N entries, for an index or group index corresponding to the one or more indices configured to the UE as mentioned herein. For an index(i) or group index(i) corresponding to the one or more indices configured to the UE that the UE finds, the UE determines the starting CCE(i)/PDCCH candidate(i) and the aggregation level(i) and payload size(i)/DCI Format(i) of an entry(i) corresponding to index(i) and the UE receives and decodes the PDCCH candidate. The starting CCE(i) can be included in the payload of Channel A as illustrated in Table 5, or can be calculated by summing over the previous aggregation levels as mentioned herein.

In Table 5 and in Table 6, the payload size or DCI Format can be provided by a code point corresponding to one of the configured payload sizes or DCI Formats. In one example, the payload sizes or DCI Formats are common for a search space across indexes or aggregation levels and hence don't depend on index(i)/group index(i). In one example, different payload sizes or different DCI Formats can be configured for each index(i)/group index(i) and/or aggregation level, hence the value corresponding to code point of DCI Format(i) or payload size(i) depends on index(i)/group index(i) and/or aggregation level(i). In one example, the size of bit field for DCI Format(i) or payload size(i) can be determined by index(i)/group index(i) with the largest number of associated DCI Formats or payload sizes. For example, if the largest number of DCI Formats or largest number of payload sizes associated to an entry is K, the size of the DCI Format field of payload size field in Table 5 or Table 6 is log₂ K or ┌log₂ K┐.

In one example, a DCI format X or a downlink information (DI) provided by Channel A (also referred to as ‘PDICH’) includes one or more of the following fields:
an index for an associated CORESET, if not provided/indicated/determined by the configuration of Channel A; e.g., [3] bits. In one example, there is one CORESET index in channel A common to entries. In one example, is a CORESET index in channel A per entry or block.
an index for an associated search space set, if not provided/indicated/determined by the configuration of Channel A; e.g., [6] bits. In one example, there is one search space set index in channel A common to entries. In one example, is a search space set index in channel A per entry or block.
a number N of blocks, block index 0, block index 1, . . . , block index N−1:
   In one example, each block corresponding to a starting bit position ‘positionInDCI’. In one example, each block can include one or more of the following fields:
      UE index in the group, at least when the associated search space set is not a cell-specific CSS set e.g., [3-5] bits
      Monitoring occasion index [1-3] bits
      Cell index e.g., [1-3] bits to indicate the cell to which the PDCCH applies;
      Starting CCE index in the associated CORESET [C] bits, e.g., [4-8] bits
      AL value; e.g., [2-3] bits;
CRC e.g., [16] bits. In one example the CRC is scrambled by DI-RNTI. In one example the CRC is not scrambled by DI-RNTI.

The size of the DCI format X or DI is directly/explicitly configured by RRC or is determined by the UE based on the field descriptions herein and corresponding configurations.

FIG. 18 illustrates example entries 1800 for CCEs according to embodiments of the present disclosure. For example, entries 1800 for CCEs can be received by any of the UEs 111-116 of FIG. 1, such as the UE 112. This example is for illustration only and other embodiments can be used without departing from the scope of the present disclosure.

In one example, the payload of Channel A includes a field map with an entry for each CCE as illustrated in FIG. 18. In one example, the PDCCH MO associated with Channel A has N CCEs as illustrated in FIG. 18. In one example, an index can be repeated multiple times in CCE field map of FIG. 18, this can correspond to a PDCCH candidate with aggregation level larger than one and/or multiple PDCCH candidates for a same index.

In one example, an entry corresponding to CCE(i) includes an index configured as mentioned herein. In one example, an index is a UE index. In one example, an index is an RNTI index. In one example, the UE receives the channel associated with a monitoring occasion of a search space, e.g., Channel A. The UE searches the N entries corresponding to the N CCEs, for an index corresponding to the one or more indices configured to the UE as mentioned herein. For each index corresponding to the one or more indices configured to the UE that the UE finds, the UE receives and decodes the corresponding PDCCH. In one example, if a UE is configured with index I and with aggregation level K, and index I is repeated at least K times starting from CCE n·K, where n is an integer, i.e., CCE n·K, n·K+1, . . . , n·K+K−1 indicate index I, the UE receives and decodes a PDCCH candidate starting from CCE n·K, with an aggregation level K, and based on index I, for example, index I and/or aggregation level can determine the payload size and/or DCI Format, or multiple payload sizes and/or DCI Formats and the UE does hypothesis decoding.

In one example, let the UE be configured with index I, and aggregation levels 2, and 3. Let Channel A, indicate index I in CCEs corresponding CCE(4), CCE(5), CCE(6) and CCE(7). In this example, the UE can decode the following PDCCH candidates:
PDCCH candidate starting at CCE(4) and with aggregation level 2
PDCCH candidate starting at CCE(6) and with aggregation level 2
PDCCH candidate starting at CCE(4) and with aggregation level 4

The UE can check the CRC to determine which PDCCH candidate, if any, is successfully decoded.

In one example, an entry corresponding to CCE(i) includes: (1) an index configured as mentioned herein, and (2) a code point(s) corresponding to a payload size and/or DCI format. In one example, an index is a UE index. In one example, an index is an RNTI index. In one example, the UE receives the channel associated with a monitoring occasion of a search space, e.g., Channel A. The UE searches the N entries corresponding to the N CCEs, for an index corresponding to the one or more indices configured to the UE as mentioned herein. For an index corresponding to the one or more indices configured to the UE that the UE finds, the UE receives and decodes the corresponding PDCCH based on the indicated code point(s) of the payload size and/or DCI Format. In one example, if a UE is configured with index I and with aggregation level K, and index I is repeated at least K times starting from CCE n·K, where n is an integer, i.e., CCE n·K, n·K+1, . . . , n·K+K−1 indicate index I, and a same code point(s) for payload size and/or DCI Format, the UE receives and decodes a PDCCH candidate starting from CCE n·K, with an aggregation level K, and based on index I and the corresponding payload size and/or DCI Format. In one example, the code point of the payload size and/or DCI Format and index I and the aggregation level can determine the payload size and/or DCI Format.

In one example, an entry corresponding to CCE(i) includes: (1) an index configured as mentioned herein, and (2) a flag to indicate the starting CCE. In one example, an index is a UE index. In one example, an index is an RNTI index. In one example, a flag is 1 for a starting CCE of a PDCCH candidate and 0 otherwise. In one example, a flag is 0 for a starting CCE of a PDCCH candidate and 1 otherwise. In one example, the UE receives the channel associated with a monitoring occasion of a search space, e.g., Channel A. The UE searches the N entries corresponding to the N CCEs, for an index corresponding to the one or more indices configured to the UE as mentioned herein. For an index corresponding to the one or more indices configured to the UE that the UE finds, the UE receives and decodes the corresponding PDCCH. In one example, the UE starts decoding a PDCCH candidate starting from a CCE A, where CCE A has a flag indicating a starting CCE and index I configured to the UE, until first CCE B, where CCE B+1 has a flag indicating a starting CCE or CCE B+1 has index J different from index I, or CCE B is the last CCE of the CORESET. In one example, index I and/or aggregation level can determine the payload size and/or DCI Format, or multiple payload sizes and/or DCI Formats and the UE does hypothesis decoding. The UE can check the CRC to determine which PDCCH candidate, if any, is successfully decoded.

In one example, an entry corresponding to CCE(i) includes: (1) an index configured as mentioned herein, (2) a flag to indicate the starting CCE, and (3) a code point(s) corresponding to a payload size and/or DCI format. In one example, an index is a UE index. In one example, an index is an RNTI index. In one example, a flag is 1 for a starting CCE of a PDCCH candidate and 0 otherwise. In one example, a flag is 0 for a starting CCE of a PDCCH candidate and 1 otherwise. In one example, the UE receives the channel associated with a monitoring occasion of a search space, e.g., Channel A. The UE searches the N entries corresponding to the N CCEs, for an index corresponding to the one or more indices configured to the UE as mentioned herein. For an index corresponding to the one or more indices configured to the UE that the UE finds, the UE receives and decodes the corresponding PDCCH based on the indicated code point(s) of the payload size and/or DCI Format. In one example, the UE starts decoding a PDCCH candidate starting from a CCE A, where CCE A has a flag indicating a starting CCE and index I configured to the UE, until first CCE B, where CCE B+1 has a flag indicating a starting CCE or CCE B+1 has index J different from index I, or CCE B is the last CCE of the CORESET. In one example, the code point of the payload size and/or DCI Format and index I can determine the payload size and/or DCI Format.

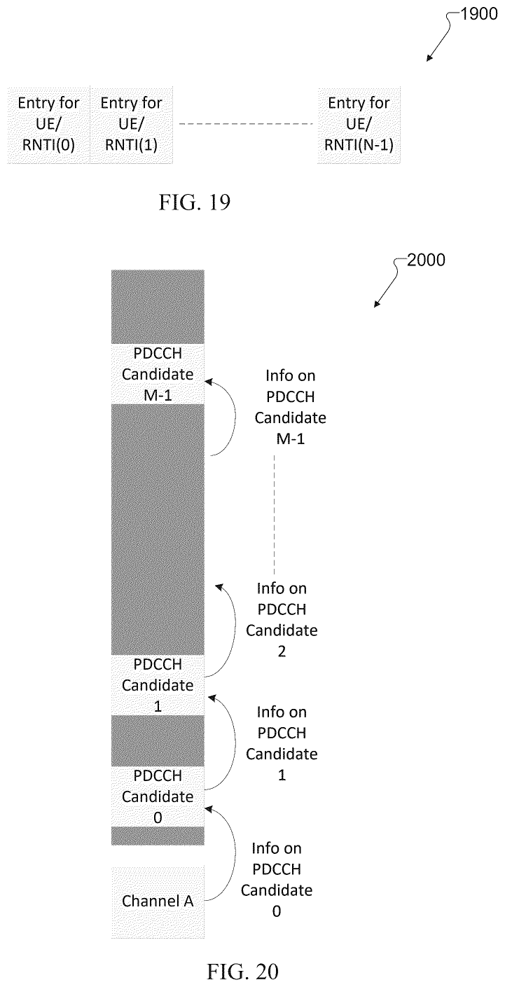

FIG. 19 illustrates example entries 1900 for RNTIs according to embodiments of the present disclosure. For example, entries 1900 for RNTIs can be received by any of the UEs 111-116 of FIG. 1, such as the UE 112. This example is for illustration only and other embodiments can be used without departing from the scope of the present disclosure.

In one example, the payload of Channel A includes a field map or block map with an entry for each UE or RNTI as illustrated in FIG. 19. In one example, the UE can be configured a starting location (e.g., starting bit, or positionInDCI) and number of bits of a field map or a bitmap corresponding to the UE. In one example, the UE can be configured a starting location (e.g., starting bit or positionInDCI) and number of bits of a field map or a bitmap corresponding to an RNTI.

In one example an entry corresponding to UE/RNTI(i) includes a starting CCE index (e.g., CCEₛₜₐᵣₜ) of a PDCCH candidate or an index of candidate PDCCH in a PDCCH MO corresponding to Channel A for UE/RNTI(i). In one example, a UE is configured with a set of aggregation levels, e.g., {AL₀, AL₁ . . . , AL_{L-1}} for search space set associated with Channel A. In one example, for aggregation level ALₗ, where ALₗ∈{AL₀, AL₁ . . . , AL_{L-1}}, if CCEₛₜₐᵣₜ=n·ALₗ, where n is an integer the UE decodes a PDCCH candidate starting at CCEₛₜₐᵣₜ, with aggregation level ALₗ (e.g., for aggregation levels that satisfy CCEₛₜₐᵣₜ=n·ALₗ). In one example, the UE decodes multiple PDCCH candidates with different aggregation levels (e.g., as configured), starting from CCEₛₜₐᵣₜ. The UE can check the CRC to determine which PDCCH candidate, if any, is successfully decoded. In one example, a UE can determine a payload size or DCI Format or multiple payload sizes and/or DCI Formats for a search space and/or RNTI and/or aggregation level, and the UE does hypothesis decoding. The UE can check the CRC to determine which PDCCH candidate, if any, is successfully decoded.

In one example an entry corresponding to UE/RNTI(i) includes: (1) a starting CCE index (e.g., CCEₛₜₐᵣₜ) of a PDCCH candidate or an index of candidate PDCCH in a PDCCH MO corresponding to Channel A for UE/RNTI(i), and (2) an aggregation level ALₗ. In one example, the aggregation level is a code point corresponding an entry from the set {AL₀, AL₁ . . . , AL_{L-1}}, where the UE is configured with a set of aggregation levels, e.g., {AL₀, AL₁ . . . , AL_{L-1}} for search space set associated with Channel A. In one example, UE decodes a PDCCH candidate starting at CCEₛₜₐᵣₜ, with aggregation level ALₗ. In one example, the UE expects that CCEₛₜₐᵣₜ=n·ALₗ, where n is an integer. In one example, a UE can determine a payload size or DCI Format or multiple payload sizes and/or DCI Formats for a search space and/or RNTI and/or aggregation level, and the UE does hypothesis decoding. The UE can check the CRC to determine which PDCCH candidate, if any, is successfully decoded.

In one example an entry corresponding to UE/RNTI(i) indicates (1) a starting CCE index (e.g., CCEₛₜₐᵣₜ) of a PDCCH candidate or an index of candidate PDCCH in or an index of candidate PDCCH corresponding to Channel A for UE/RNTI(i), and (2) an aggregation level ALₗ.

In one example, if the aggregation levels configured, to the UE for a search space are {AL₀, AL₁ . . . , AL_{L-1}}, and the number of PDCCH candidates for each aggregation level are {NC₀, NC₁ . . . , NC_{L-1}}. In one example, {NC₀, NC₁ . . . , NC_{L-1}} are configured to the UE for a search space set. In one example, {NC₀, NC₁ . . . , NC_{L-1}} are determined, such that NCₗ=N/ALₗ, where N is the number of CCEs of a CORESET or PDCCH MO associated with Channel A. In one example, {NC₀, NC₁ . . . , NC_{L-1}} are determined, such that NCₗ=└N/ALₗ┘, where N is the number of CCEs of a CORESET or PDCCH MO associated with Channel A. In one example, for starting CCE CCEₛₜₐᵣₜ, with aggregation level ALₗ, the UE can be indicated, in Channel A, index (e.g., index of PDCCH candidate)

$$\frac{{CCE}_{s t a r t}}{{AL}_{l}} + {\sum }_{i = 0}^{l - 1} {AL}_{i} {NC}_{i} , or \frac{{CCE}_{s t a r t}}{{AL}_{l}}$$

(where the UE is indicated the aggregation level and the index of the PDCCH candidate for that aggregation level). In one example, a UE can determine a payload size or DCI Format or multiple payload sizes and/or DCI Formats for a search space and/or RNTI, and the UE does hypothesis decoding. The UE can check the CRC to determine which PDCCH candidate, if any, is successfully decoded.

In one example, the UE is configured with a search space having {AL₀, AL₁ . . . , AL_{L-1}} aggregation levels, and number of PDCCH candidate per aggregation level is {NC₀, NC₁ . . . , NC_{L-1}}.
In one example, an entry corresponding to UE/RNTI(i) includes (1) Aggregation level l, e.g., this can be indicated by a field with size ┌log₂ L┐, where L is the number if aggregation levels and (2) a PDCCH candidate index, j, for aggregation level l, for example, this can be a value form 0, 1, . . . , NCₗ−1, e.g., this can be indicated by a field with size ┌log₂(max (over k) NCₖ)┐.
In one example, an entry corresponding to UE/RNTI(i) includes a value A, where

$$A = {\sum }_{k = 0}^{l - 1} {NC}_{k} + j ,$$

where l is the aggregation level and j is the PDCCH candidate index for aggregation level l, where j=0, 1, . . . , NCₗ−1, e.g., this can be indicated by a field with size

$$⌈ {log}_{2} {\sum }_{k = 0}^{L - 1} {NC}_{k} ⌉ .$$

In one example, the UE can determine the starting CCE index for aggregation level l and PDCCH candidate index j using a hash function as mentioned herein. For example,

$${CCE}_{start} = L \cdot \{ ( {Y}_{p , {n}_{s , f}^{μ}} + ⌊ \frac{{m}_{s , {n}_{CI}}^{( L )} \cdot {N}_{CCE , p}}{L \cdot {M}_{s , max}^{( L )}} ⌋ + {n}_{CI} ) mod ⌊ {N}_{CCE , p} / L ⌋ \}$$

### Where,

$${m}_{s , {n}_{CI}}^{( L )} = j ,$$

L=l. Other parameters can be as previously defined or as described in [REF 3].

FIG. 20 illustrates examples of PDCCH candidate information 2000 according to embodiments of the present disclosure. For example, PDCCH candidate information 2000 can be received by any of the UEs 111-116 of FIG. 1, such as the UE 114. This example is for illustration only and other embodiments can be used without departing from the scope of the present disclosure.

In one example, multiple (e.g., M) PDCCH candidates are transmit to a UE or an RNTI. In one example, Channel A for UE/RNTI(i) includes the CCE index of a first PDCCH candidate (e.g., PDCCH (0)) according to the examples described herein. In one example, Channel A for UE/RNTI(i) includes the CCE index and aggregation level of a first PDCCH candidate (e.g., PDCCH (0)) according to the examples described herein. In one example, Channel A for UE/RNTI(i) indicates the CCE index and aggregation level of a first PDCCH candidate (e.g., PDCCH (0)) according to the examples described herein. In one example, Channel A for UE/RNTI(i) includes or indicates a PDCCH candidate index of a first PDCCH candidate (e.g., PDCCH (0)) according to the examples described herein. In one example, Channel A for UE/RNTI(i) includes or indicates a PDCCH candidate index and aggregation level of a first PDCCH candidate (e.g., PDCCH (0)) according to the examples described herein. In one example, the mth PDCCH candidate (e.g., PDCCH (m−1)) includes information about (m+1)th PDCCH as illustrated in FIG. 20, m=1, 2, . . . . Information can include or indicate resource allocation (e.g., starting CCE/aggregation level/PDCCH candidate index), payload size and/or DCI Format.

In one example, the mth PDCCH candidate (e.g., PDCCH (m−1)) includes a starting CCE index (e.g., CCEₛₜₐᵣₜ) of the (m+1)th PDCCH candidate or an index of candidate PDCCH (e.g., PDCCH(m)) in a PDCCH MO, where m=1, 2, . . . , M−1. In one example, a UE is configured with a set of aggregation levels, e.g., {AL₀, AL₁ . . . , AL_{L-1}} for search space set associated with Channel A. In one example, for aggregation level ALₗ, where ALₗ∈{AL₀, AL₁ . . . , AL_{L-1}}, if CCEₛₜₐᵣₜ=n·ALₗ, where n is an integer the UE decodes a PDCCH candidate starting at CCEₛₜₐᵣₜ, with aggregation level ALₗ. In one example, the UE decodes multiple PDCCH candidates for PDCCH(m) with different aggregation levels (e.g., as configured), starting from CCEₛₜₐᵣₜ. The UE can check the CRC to determine which PDCCH candidate, if any, is successfully decoded. In one example, a UE can determine a payload size or DCI Format or multiple payload sizes and/or DCI Formats for a search space and/or RNTI, and the UE does hypothesis decoding. The UE can check the CRC to determine which PDCCH candidate, if any, is successfully decoded. In one example, the starting CCE index can be the absolute starting CCE index in the CORESET or PDCCH MO. In one example, the starting CCE index can be the relative starting CCE index of PDCCH(m) relative to PDCCH(m−1).

In one example, the mth PDCCH candidate (e.g., PDCCH(m−1)) includes: (1) a starting CCE index (e.g., CCEₛₜₐᵣₜ) of the (m+1)th PDCCH candidate or an index of candidate PDCCH (e.g., PDCCH(m)) in PDCCH MO, where m=1, 2, . . . , M−1, and (2) an aggregation level ALₗ for the (m+1)th PDCCH candidate (e.g., PDCCH(m)). In one example, the aggregation level is a code point corresponding to an entry from the set {AL₀, AL₁ . . . , AL_{L-1}}, where the UE is configured with a set of aggregation levels, e.g., {AL₀, AL₁ . . . , AL_{L-1}} for a search space set. In one example, UE decodes a PDCCH candidate (e.g., PDCCH(m)) starting at CCEₛₜₐᵣₜ, with aggregation level ALₗ. In one example, a UE can determine a payload size or DCI Format or multiple payload sizes and/or DCI Formats for a search space and/or RNTI, and the UE does hypothesis decoding. The UE can check the CRC to determine which PDCCH candidate, if any, is successfully decoded. In one example, the starting CCE index can be the absolute starting CCE index in the CORESET or PDCCH MO. In one example, the starting CCE index can be the relative starting CCE index of PDCCH(m) relative to PDCCH(m−1).

In one example, the mth PDCCH candidate (e.g., PDCCH(m−1)) indicates (1) a starting CCE index (e.g., CCEₛₜₐᵣₜ) of the (m+1)th PDCCH candidate (e.g., PDCCH(m)) in the CORESET or monitoring occasion, where m=1, 2, . . . , M−1, and (2) an aggregation level ALₗ for the (m+1)th PDCCH candidate (e.g., PDCCH(m)).

In one example, if the aggregation levels configured, to the UE for a search space are {AL₀, AL₁ . . . , AL_{L-1}}, and the number of PDCCH candidates for each aggregation level are {NC₀, NC₁ . . . , NC_{L-1}}. In one example, {NC₀, NC₁ . . . , NC_{L-1}} are configured to the UE for a search space set. In one example, {NC₀, NC₁ . . . , NC_{L-1}} are determined, such that NCₗ=N/ALₗ, where N is the number of CCEs of a CORESET or PDCCH MO. In one example, {NC₀, NC₁ . . . , NC_{L-1}} are determined, such that NCₗ=└N/ALₗ┘, where N is the number of CCEs of a CORESET or monitoring occasion associated with Channel A. In one example, for starting CCE CCEₛₜₐᵣₜ, with aggregation level ALₗ, the UE can be indicated, in PDCCH(m−1), index

$$\frac{{CCE}_{start}}{A {L}_{l}} + {\sum }_{i = 0}^{l - 1} {AL}_{i} {NC}_{i} or \frac{{CCE}_{start}}{{AL}_{l}}$$

(where the UE is indicated the aggregation level and the index of the PDCCH candidate for that aggregation level) for PDCCH(m). In one example, the UE can be indicated index of PDCCH(m) relative to index of PDCCH(m−1). In one example, a UE can determine a payload size or DCI Format or multiple payload sizes and/or DCI Formats for a search space and/or RNTI, and the UE does hypothesis decoding. The UE can check the CRC to determine which PDCCH candidate, if any, is successfully decoded.

In one example, the UE is configured with a search space having {AL₀, AL₁ . . . , AL_{L-1}} aggregation levels, and number of PDCCH candidate per aggregation level is {NC₀, NC₁ . . . , NC_{L-1}}.
In one example, a UE can be indicated in PDCCH candidate(m−1), the following information for PDCCH candidate(m): (1) Aggregation level l, e.g., this can be indicated by a field with size ┌log₂ L┐, and (2) a PDCCH candidate index, j, for aggregation level l, for example, this can be a value form 0, 1, . . . , NCₗ−1, e.g., this can be indicated by a field with size ┌log₂(max (over k) NCₖ)┐.
In one example, a UE can be indicated in PDCCH candidate(m−1), the following information for PDCCH candidate(m): a value A, where

$$A = {\sum }_{k = 0}^{l - 1} {NC}_{k} + j ,$$

where l is the aggregation level and j is the PDCCH candidate index for aggregation level l, where j=0, 1, . . . , NCₗ−1, e.g., this can be indicated by a field with size

$$⌈ {log}_{2} {\sum }_{k = 0}^{L - 1} {NC}_{k} ⌉ .$$

In one example, a PDCCH candidate includes a CRC, and the CRC is not scrambled with an RNTI.

In one example, a PDCCH candidate includes a CRC, and the CRC is scrambled with an RNTI.

In one example, a PDCCH candidate has a 24-bit CRC.

In one example, a PDCCH candidate has a 16-bit CRC.

The following are example based on the examples described herein:

In one example, a UE is configured with two search space sets, a first search space set (e.g., USS1) with configured for DCI Format 1_0, and with CCE aggregation level (AL)=1 and AL=2. A second search space set (e.g., USS2) with configured for DCI Format 1_1, and with CCE aggregation level (AL)=4 and AL=8.

In one example, a UE is configured with a first Channel A (e.g., A1) associated with or linked to USS1. A UE is configured with a second Channel A (e.g., A2) associated with or linked to USS2. If a UE receives A1, the UE extracts the information about candidate PDCCH(s) in a corresponding PDCCH MO of USS1 transmitted to the UE, this for example can be based on a block of bits in Channel A associated with the UE or based on an entry in Channel A (e.g., based on an index as mentioned herein) associated with the UE. If a UE receives A2, the UE extracts the information about candidate PDCCH(s) in a corresponding PDCCH MO of USS2 transmitted to the UE, this for example can be based on a block of bits in Channel A associated with the UE or based on an entry in Channel A (e.g., based on an index as mentioned herein) associated with the UE. The information about the candidate PDCCH(s) in respective A1 and A2, can include or indicate one or more of the index of candidate PDCCH, CCE index(es) of candidate PDCCH, starting CCE index, CCE AL, . . . .

In one example, a UE (e.g., the UE 116) is configured with a Channel A (e.g., A1) associated with or linked to USS1 and USS2. If a UE receives Channel A, the UE extracts the information about the search space set (e.g., USS1 or USS2) and candidate PDCCH(s) in a corresponding PDCCH MO of indicated search space set transmitted to the UE, this for example can be based on a block of bits in Channel A associated with the UE or based on an entry in Channel A (e.g., based on an index as mentioned herein) associated with the UE. In one example, the search space set can be indicated explicitly, e.g., by a field in Channel A that indicates the search space set of the PDCCH candidate. In one example, the search space set can be indicated implicitly, e.g., if the UE indicates an AL, the AL can determine the search space set (e.g., of AL=1 or AL=2 is indicated in Channel A, this corresponds to USS1, while if AL=4 or AL=8 is indicated in Channel A, this corresponds to USS2). The PDCCH information can as mentioned herein according to one or more examples described herein, in addition to the indication of the search space set.

In one example, the addressable PDCCH candidates of a UE are PDCCH candidates for a CCE AL in the CORESET of a PDCCH MO. This for example, can provide maximum flexibility and least blocking for transmitting PDCCH candidates to a UE, but can require more bits for indication in Channel A. In another example, a UE is configured a number of PDCCH candidates, e.g., the number of PDCCH candidates is configured per CCE AL. In one example, the UE can determine the PDCCH candidates based on a hashing function. This for example, reduces the number of addressable PDCCH candidates, hence requires less bits in corresponding field of Channel A, but can have a higher blocking probability.

In one example, the addressable candidate PDCCHes can be across CCE ALs. The UE can be indicated an index of a candidate PDCCH, this can determine the starting CCE and the CCE AL.
In one example, if a CORESET of a PDCCH MO has 16 CCEs, the number of candidate PDCCHes per AL, for AL={1,2,4,8} is {16,8,4,2} respectively, total number of candidate PDCCHes is 16+8+4+2=30, hence a 5-bit field is sufficient to address any candidate PDCCH.
In on example, if a UE is configured for AL={1,2,4,8} can number of candidates PDCCHes={3,3,1,1} respectively, a total number of candidate PDCCHes is 3+3+1+1=8, hence a 3-bit field is sufficient to address any candidate PDCCH.

In one example, the addressable candidate PDCCHes can be per CCE ALs. The UE can be indicated an index of a candidate PDCCH for CCE AL, as well as a CCE AL.
In one example, if a CORESET of a PDCCH MO has 16 CCEs, the number of candidate PDCCHes per AL, for AL={1,2,4,8} is {16,8,4,2} respectively, 4-bits can be used to indicate the PDCCH candidate for a CCE AL (this is based AL=1, with the largest number of candidate PDCCH(es) of 16). 2-bits can be used to indicate the CCE AL (one of 4 values). Hence, a total of 6-bits are used to indicate the PDCCH candidate (including starting CCE and CCE AL).
In on example, if a UE is configured for AL={1,2,4,8} a number of candidates PDCCHes={3,3,1,1} respectively, 2-bits can be used to indicate the PDCCH candidate for a CCE AL (this is based AL=1 and AL=2, with the largest number of candidate PDCCH(es) of 3). 2-bits can be used to indicate the CCE AL (one of 4 values). Hence, a total of 4-bits are used to indicate the PDCCH candidate (including starting CCE and CCE AL).

In one example, a UE is configured with two search space sets, a first search space set (e.g., USS1) is configured for DCI Format 1_0, and with CCE aggregation level (AL)=1 and AL=2 and AL=4. A second search space set (e.g., USS2) is configured for DCI Format 1_1, and with CCE aggregation level (AL)=4 and AL=8. In this example, AL=4 can correspond to DCI Format 1_0 and DCI Format 1_1, if the UE is indicated the search space set ID in Channel A (e.g., similar to explicit indication according to one or more examples described herein), the UE can determine the DCI Format to receive for a PDCCH candidate.

In one example, a UE is configured with a search space set, the search space set is configured with AL=1 and AL=2 for DCI Format 1_0. The search space set is configured with AL=4 and AL=8 for DCI Format 1_1. The UE is configured with a Channel A associated with or linked to the search space set.

If a UE receives Channel A, the UE extracts the information about candidate PDCCH(s) in a corresponding PDCCH MO of search space set transmitted to the UE, this for example can be based on a block of bits in Channel A associated with the UE or based on an entry in Channel A (e.g., based on an index as mentioned herein) associated with the UE. The information about candidate PDCCH(s) can be as mentioned herein (e.g., according to one or more examples described herein). The information about candidate PDCCH(s) can indicate a CCE AL, which in combination with the search space set configuration information can be used to determine the DCI Format to receive for a PDCCH candidate.

In one example, a UE is configured with a search space set, the search space set is configured with AL=1, AL=2 and AL=4 for DCI Format 1_0. The search space set is configured with AL=2, AL=4 and AL=8 for DCI Format 1_1. The UE is configured with a Channel A associated with or linked to the search space set.

If a UE receives Channel A, the UE extracts the information about candidate PDCCH(s) in a corresponding PDCCH MO of search space set transmitted to the UE, this for example can be based on a block of bits in Channel A associated with the UE or based on an entry in Channel A (e.g., based on an index as mentioned herein) associated with the UE. The information about candidate PDCCH(s) can be as mentioned herein (e.g., according to one or more examples described herein). In this example, if Channel A indicated AL=1 or AL=8 for a candidate PDCCH, the UE can determine the DCI Format of the candidate PDCCH (e.g., DCI Format 1_0 or DCI Format 1_1 respectively). If the UE is indicated AL=2 or AL=4, the DCI Format of the candidate PDCCH can be DCI Format 1_0 or DCI Format 1_1.

In one example, if a UE is indicated for a candidate PDCCH, AL=2 or AL=4, the UE can try multiple decode hypothesis for DCI Format 1_0 and DCI Format 1_1 and check which DCI Format has a passing CRC (DCI Format is successful decoded), if any.

In one example, a UE can be additionally be indicated a DCI Format in Channel A. Based on the indicated DCI Format in Channel A, along with other information about the candidate PDCCH, the UE decodes the candidate PDCCH.

In one example, a search space set can be associated with one DCI Format.

In one example, a search space set can be associated with one or more DCI Formats, and the DCI Formats can have a same payload size. In one example, the DCI Format can include a field to indicate the type of DCI Format. The UE can decode the candidate PDCCH based on the same size of the DCI Formats, the UE can read or check the field or RNTI scrambling CRC to determine the type of DCI Format and interpret DCI Format payload accordingly (alternatively this information can be indicated in Channel A).

In one example, a search space set can be associated with one or more DCI Formats, and the DCI Formats can have a different payload sizes.
In one example, the DCI Format or DCI Format(s) associated with a CCE AL can have a same payload size. Based on the CCE AL, e.g., indicated in Channel A, the UE can decode the candidate PDCCH based on the same size of the DCI Format(s), and if more than one DCI Format with the same payload size, the UE can read or check a field or RNTI scrambling CRC in the DCI Format to determine the type of DCI Format and interpret DCI Format payload according (alternatively this information can be indicated in Channel A).
In one example, the UE can try multiple decode hypothesis for the different DCI Formats associated with the search space set.
In one example, the UE can try multiple decode hypothesis for the different DCI Formats associated with the search space set and indicated CCE AL in Channel A.
In one example, the UE can be additionally indicated a DCI Format in Channel A.

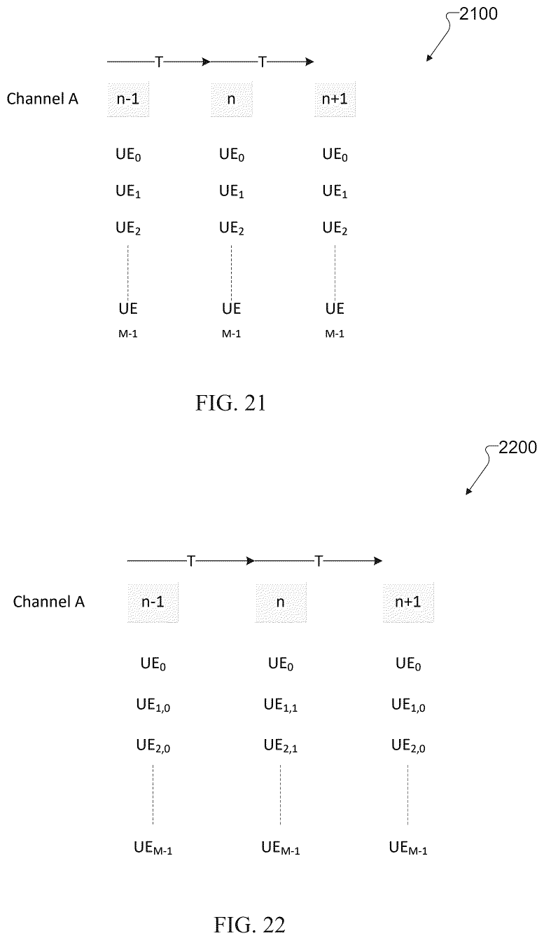

FIG. 21 illustrates an example periodicity 2100 of channel A according to embodiments of the present disclosure. For example, periodicity 2100 of channel A. For example, periodicity 2100 of channel A can be monitored by any of the UEs 111-116 of FIG. 1, such as the UE 116. This example is for illustration only and other embodiments can be used without departing from the scope of the present disclosure.

In one example, a UE is configured resources for Channel A or for a MO for Channel A. The resources for Channel A or for the MO of Channel A are configured with a periodicity T as illustrated in FIG. 21. In one example, Channel A can contain information to a UE. In one example, Channel A can contain information to a more than one UE. In one example, Channel A can contain information to UEs in a cell. In one example, Channel A contains an entry for a UE, wherein the entry for the UE is determined based on an index in that entry for the UE. In one example, Channel A contains a block of bits for a UE, wherein the block of bits for a UE is determined based a start bit location and a number of bits for the UE. In one example, UEs associated with Channel A are configured to receive Channel A with a same period T.

In FIG. 21, instance n−1 of Channel A is addressed to M users; UE₀, UE₁, UE₂ . . . , UE_{M-1}. Similarly, instances n and n+1 are addressed to the same M users; UE₀, UE₁, UE₂ . . . , UE_{M-1}.

FIG. 22 illustrates an example periodicity 2200 of channel A according to embodiments of the present disclosure. For example, periodicity 2200 of channel A can be monitored by the UE 116 of FIG. 3. This example is for illustration only and other embodiments can be used without departing from the scope of the present disclosure.

In one example, the users addressed by Channel A, e.g., with a periodicity T can have different receive periodicities (e.g., integer multiples of T) and different offsets as illustrated in FIG. 22. In FIG. 22, instance n−1 of Channel A is addressed to M users; UE₀, UE_{1,0}, UE_{2,0} . . . , UE_{M-1}. Instance n is addressed to M users; UE₀, UE_{1,1}, UE_{2,1} . . . , UE_{M-1}. While instance n+1 is addressed to M users; UE₀, UE_{1,0}, UE_{2,0} . . . , UE_{M-1}. In this example, users UE₀ and UE_{M-1} receive Channel A with a periodicity T, while users UE_{1,0}, UE_{1,1}, UE_{2,0} and UE_{2,1} receive Channel A with a periodicity 2T. Users UE_{1,0} and UE_{1,1} can share same index for an entry of Channel A or a same block bits of Channel A, they are staggered in time by T, hence they receive Channel A at different instances. Similarly, Users UE_{2,0} and UE_{2,1} can share same index for an entry of Channel A or a same block bits of Channel A, they are staggered in time by T, hence they receive Channel A at different time instances.

In one example, if Channel A has a period of T, and a user is configured to receive Channel A with a period K T. The UE can be configured with a relative offset of k=0, 1, . . . , K−1 to receive one instances of Channel A every K instances of Channel A. For example, depending on the periodicity and frequency of traffic to a UE, the receive periodicity of channel A can be adjusted to optimize UE power consumption.

In one example, the periodicity of Channel A T (e.g., as illustrated in FIG. 21) can be updated, e.g., the update can be L1 control (e.g., DCI Format) signaling and/or MAC CE signaling and/or by RRC signaling. In one example, the update of Channel A periodicity T can be indicated in Channel A for future instances of Channel A. In one example, the UE can be indicated/configured/re-configured an offset within the period T to receive Channel A. In one example, the new configuration (e.g., periodicity and/or offset) for the Channel A can be at or after a time T₁ from the start or end of the channel/signal carrying the new configuration. In one example, the new configuration (e.g., periodicity and/or offset) for the Channel A can be at or after a time T₁ from the start or end of the acknowledgment to the channel/signal carrying the new configuration. In one example, T₁ can be updated and/or configured by SIB and/or RRC and/or MAC-CE and/or L1 control (e.g., DCI Format signaling). In one example, T₁ depends on a UE capability.

In one example, the periodicity K (where K is a multiple of the Channel A periodicity T to receive Channel A at a UE as illustrated in FIG. 22) and/or offset to receive Channel A (e.g., k=0, 1, . . . , K−1) can be updated by L1 control (e.g., DCI Format) signaling and/or MAC CE signaling and/or by RRC signaling. In one example, the update of Channel A receive periodicity T and/or offset at a UE can be indicated in Channel A for future instances of Channel A. For example, depending on the periodicity and frequency of traffic to a UE, the receive periodicity of channel A can be adjusted to optimize UE power consumption. In one example, the new configuration (e.g., periodicity and/or offset) for the reception of Channel A at a UE can be at or after a time T₁ from the start or end of the channel/signal carrying the new configuration. In one example, the new configuration (e.g., periodicity and/or offset) for the Channel A can be at or after a time T₁ from the start or end of the acknowledgment to the channel/signal carrying the new configuration. In one example, T₁ can be updated and/or configured by SIB and/or RRC and/or MAC-CE and/or L1 control (e.g., DCI Format signaling). In one example, T₁ depends on a UE capability.

In one example, a UE can be configured to stop or suspend the reception of Channel A. In one example, the request to stop or suspend the reception of Channel A can be by L1 control (e.g., DCI Format) signaling and/or MAC CE signaling and/or by RRC signaling. In one example, the request to stop or suspend the reception of Channel A can be in Channel A. In one example, the UE stops reception of Channel A at or after a time T₁ from the start or end of the channel/signal carrying the request. In one example, the UE stops reception of Channel A can be at or after a time T₁ from the start or end of the acknowledgment to the channel/signal carrying request. In one example, T₁ can be updated and/or configured by SIB and/or RRC and/or MAC-CE and/or L1 control (e.g., DCI Format signaling). In one example, T₁ depends on a UE capability.

In one example, a UE can be configured to start or resume the reception of Channel A. In one example, the request to start or resume the reception of Channel A can be by a low-power wake up signal (LP-WUS), for example the LP-WUS is received by low power radio in UE. In one example, the request to start or resume the reception of Channel A can be by a sequence-based WUS. In one example, the request to start or resume the reception of Channel A can be by L1 control (e.g., DCI Format) signaling and/or MAC CE signaling and/or by RRC signaling. In one example, the UE starts reception of Channel A at or after a time T₁ from the start or end of the channel/signal carrying the request. In one example, the UE starts reception of Channel A can be at or after a time T₁ from the start or end of the acknowledgment to the channel/signal carrying request. In one example, T₁ can be updated and/or configured by SIB and/or RRC and/or MAC-CE and/or L1 control (e.g., DCI Format signaling). In one example, T₁ depends on a UE capability.

In one example, a UE can be configured to stop or suspend the reception of Channel A for time period T₂ or for a number of receive instances L. In one example, the request to stop or suspend the reception of Channel A can be by L1 control (e.g., DCI Format) signaling and/or MAC CE signaling and/or by RRC signaling. In one example, the request to stop or suspend the reception of Channel A can be in Channel A. In one example, the UE stops or suspends the reception of Channel A starting from the next instance of Channel A. In one example, the UE stops or suspends the reception of Channel A starting from the next instance would-be receive instance of Channel A. In one example, the UE stops reception of Channel A at or after a time T₁ from the start or end of the channel/signal carrying the request. In one example, the UE stops reception of Channel A can be at or after a time T₁ from the start or end of the acknowledgment to the channel/signal carrying request. In one example, the UE starts reception of Channel A at or after a time T₂ from the start or end of the channel/signal carrying the request. In one example, the UE starts reception of Channel A can be at or after a time T₂ from the start or end of the acknowledgment to the channel/signal carrying request. In one example, the UE starts reception of Channel A at or after a time T₂ from time the UE stops receiving Channel A. In one example, the UE starts reception of Channel A at or after a time T₁+T₂ from the start or end of the channel/signal carrying the request. In one example, the UE starts reception of Channel A can be at or after a time T₁+T₂ from the start or end of the acknowledgment to the channel/signal carrying request. In one example, the UE starts reception of Channel A at or after L receive instances from the channel/signal carrying the request. In one example, the UE starts reception of Channel A can be at or after L instances from the acknowledgment to the channel/signal carrying request. In one example, the UE starts reception of Channel A at or after L receive instances from the time it stopped receiving Channel A. In one example, T₁ and/or T₂ and/or L can be updated and/or configured by SIB and/or RRC and/or MAC-CE and/or L1 control (e.g., DCI Format signaling). In one example, T₁ depends on a UE capability.

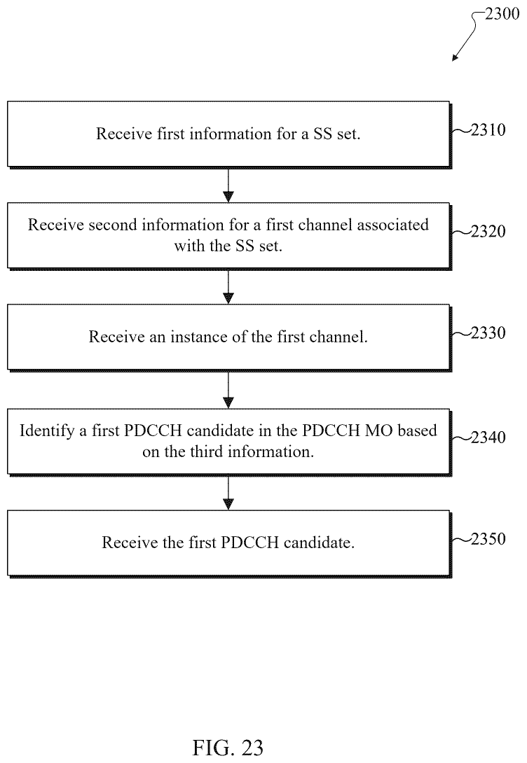

FIG. 23 illustrates an example method 2300 performed by a UE in a wireless communication system according to embodiments of the present disclosure. The method 2300 of FIG. 23 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 2300 is for illustration only and other embodiments can be used without departing from the scope of the present disclosure.

The method 2300 begins with the UE receiving first information for a SS set (2310). The UE then receives second information for a first channel associated with the SS set (2320). The UE then receives an instance of the first channel (2330). For example, in 2330, the instance of the first channel includes third information and the instance of the first channel is associated with a PDCCH MO of the SS set. In various embodiments, the second information includes information related to a block of bits within a payload of the first channel, the block of bits carries the third information, and the information includes a starting position and a size of the block of bits within the payload. In various embodiments, the third information includes a payload size of the first PDCCH candidate. In various embodiments, the third information includes a DCI format of the first PDCCH candidate. In various embodiments, the instance of the first channel is included in the PDCCH MO.

The UE then identifies a first PDCCH candidate in the PDCCH MO based on the third information (2340). For example, in 2340, the third information includes a starting CCE of the first PDCCH candidate and an AL of the first PDCCH candidate. In various embodiments, the first PDCCH candidate includes fourth information and the UE identifies a second PDCCH candidate in the PDCCH MO based on the fourth information. In various embodiments, the first PDCCH candidate includes fourth information and the UE skips reception of a number of instances of the first channel based on the fourth information. The UE then receives the first PDCCH candidate (2350).

Any of the above variation embodiments can be utilized independently or in combination with at least one other variation embodiment. The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE), comprising:
a transceiver configured to:
receive first information for a search space (SS) set,
receive second information for a first channel associated with the SS set, and
receive an instance of the first channel, wherein:
the instance of the first channel includes third information, and
the instance of the first channel is associated with a physical downlink control channel (PDCCH) monitoring occasion (MO) of the SS set; and
a processor operably coupled to the transceiver, the processor configured to, based on the third information, identify a first PDCCH candidate in the PDCCH MO,
wherein the transceiver is further configured to receive the first PDCCH candidate, and
wherein the third information indicates (i) a starting control channel element (CCE) of the first PDCCH candidate and (ii) an aggregation level (AL) of the first PDCCH candidate.

2. The UE of claim 1, wherein:
the second information includes information related to a block of bits within a payload of the first channel,
the block of bits carries the third information, and
the information includes a starting position and a size of the block of bits within the payload.

3. The UE of claim 1, wherein the third information includes a payload size of the first PDCCH candidate.

4. The UE of claim 1, wherein the third information includes a downlink control information (DCI) format of the first PDCCH candidate.

5. The UE of claim 1, wherein:
the first PDCCH candidate includes fourth information, and
the processor is further configured to, based on the fourth information, identify a second PDCCH candidate in the PDCCH MO.

6. The UE of claim 1, wherein:
the first PDCCH candidate includes fourth information, and
the processor is further configured to, based on the fourth information, skip reception of a number of instances of the first channel.

7. The UE of claim 1, wherein the instance of the first channel is included in the PDCCH MO.

8. A base station (BS), comprising:
a transceiver configured to:
transmit first information for a search space (SS) set, and
transmit second information for a first channel associated with the SS set; and
a processor operably coupled to the transceiver, the processor configured to determine third information to identify a first PDCCH candidate,
wherein the transceiver is further configured to:
transmit an instance of the first channel, wherein:
the instance of the first channel includes the third information, and
the instance of the first channel is associated with a physical downlink control channel (PDCCH) monitoring occasion (MO) of the SS set, and
transmit the first PDCCH candidate in the PDCCH MO, and
wherein the third information indicates (i) a starting control channel element (CCE) of the first PDCCH candidate and (ii) an aggregation level (AL) of the first PDCCH candidate.

9. The BS of claim 8, wherein:
the second information includes information related to a block of bits within a payload of the first channel,
the block of bits carries the third information, and
the information includes a starting position and a size of the block of bits within the payload.

10. The BS of claim 8, wherein the third information includes a payload size of the first PDCCH candidate.

11. The BS of claim 8, wherein the third information includes a downlink control information (DCI) format of the first PDCCH candidate.

12. The BS of claim 8, wherein:
the processor is further configured to determine fourth information to identify a second PDCCH candidate in the PDCCH MO, and
the first PDCCH candidate includes the fourth information.

13. The BS of claim 8, wherein:
the processor is further configured to determine fourth information to indicate to skip reception of a number of instances of the first channel, and
the first PDCCH candidate includes the fourth information.

14. The BS of claim 8, wherein the instance of the first channel is included in the PDCCH MO.

15. A method of operating a user equipment (UE), the method comprising:
receiving first information for a search space (SS) set;
receiving second information for a first channel associated with the SS set;
receiving an instance of the first channel, wherein:
the instance of the first channel includes third information, and
the instance of the first channel is associated with a physical downlink control channel (PDCCH) monitoring occasion (MO) of the SS set;
based on the third information, identifying a first PDCCH candidate in the PDCCH MO; and
receiving the first PDCCH candidate,
wherein the third information indicates (i) a starting control channel element (CCE) of the first PDCCH candidate and (ii) an aggregation level (AL) of the first PDCCH candidate.

16. The method of claim 15, wherein:
the second information includes information related to a block of bits within a payload of the first channel,
the block of bits carries the third information, and
the information includes a starting position and a size of the block of bits within the payload.

17. The method of claim 15, wherein the third information includes a payload size of the first PDCCH candidate.

18. The method of claim 15, wherein the third information includes a downlink control information (DCI) format of the first PDCCH candidate.

19. The method of claim 15, wherein:
the first PDCCH candidate includes fourth information, and
the method further comprises, based on the fourth information, identifying a second PDCCH candidate in the PDCCH MO.

20. The method of claim 15, wherein:
the first PDCCH candidate includes fourth information, and
the method further comprises, based on the fourth information, skipping reception of a number of instances of the first channel.
